(19) United States
(12) Patent Application Publication
(10) Pub. No.: US 2025/0076202 A1
(43) Pub. Date: Mar. 6, 2025

(54) SPECTROMETER SYSTEM FOR LASER-INDUCED PLASMA SPECTRAL ANALYSIS

(71) Applicant: Quantolux Innovation GmbH, Blaustein (DE)

(72) Inventors: Andreas KUNZ, Kleve (DE); Mischa OUNANIAN, Goch-Kessel (DE)

(21) Appl. No.: 18/952,244

(22) Filed: Nov. 19, 2024

Related U.S. Application Data
(63) Continuation of application No. PCT/EP2023/063002, filed on May 15, 2023.

(30) Foreign Application Priority Data
May 20, 2022 (DE) 10 2022 112 766.4

(51) Int. Cl. G01N 21/71

(52) U.S. Cl. CPC G01N 21/718; G01N 2201/021; G01N 2201/06113

(57) ABSTRACT

A spectrometer system is provided for laser-induced plasma spectral analysis having a laser beam source for emitting a laser beam and a focusing optical unit for focusing the laser beam on a sample. A plasma generation region is formed such that a surface of the sample located in the plasma generation region leads to the formation of a laser-induced plasma. The spectrometer system also comprises a detection unit for capturing plasma light. The detection unit comprises a plurality of objectives. Each of the objectives is associated with a detection cone which, in a region of overlap with the laser beam, forms a plasma detection region, such that, when the laser induced plasma is formed in one of the plasma detection regions, a measurement component of the plasma light can be captured by the corresponding objective. The plasma detection regions jointly form a field of vision of the detection unit.

### CROSS REFERENCE TO RELATED APPLICATIONS

This application is a continuation under 35 U.S.C. § 120 of International Application PCT/EP2023/063002, filed May 15, 2023, which claims priority to German Application No. 10 2022 112 766.4, filed May 20, 2022, the contents of each of which are incorporated by reference herein.

### FIELD OF THE INVENTION

The present invention relates to spectrometer systems for laser-induced plasma spectroscopy, in particular stationary spectrometer systems for spectral analysis of a plasma laser-induced on a sample positioned in a sample vessel.

### BACKGROUND

Laser-induced plasma spectroscopy—also referred to as LIBS (laser induced breakdown spectroscopy) or LIPS (laser induced plasma spectroscopy)—is used to determine the element-specific composition of a sample using a plasma. The plasma is generated with high-intensity, focused laser radiation on the surface of the sample. Light emitted by the plasma is detected and spectrally analyzed to draw conclusions about the elemental composition of the sample.

LIBS systems are known from the state of the art, which measure a height profile of the sample for correctly focusing the laser beam onto the surface and adjust the spectrometer in its distance accordingly. An automatic focusing device is disclosed, e.g., in CN 107783242 A. CN 216 284 940 U discloses a scanning device for laser emission spectroscopy, wherein the scanning device allows parameters such as an initial position, a center of movement of a spiral movement track to be set so that a movement track with a spiral uniform linear velocity movement can be affected. Furthermore, portable devices with, e.g., one or more spectrometers are also known, see, e.g., U.S. Pat. No. 11,085,882 BL. CN 110220871 A und CN 103 604 780 A disclose LIBS plasma spectral collection systems with a focusing microscope objective and two lens-fiber units mounted laterally in an adjustment frame and aligned with a plasma focus point. CN 102 967 587 A discloses such a structure for an optical detection probe for molten liquid components.

US 2021/341392 relates to laser-induced ablation spectroscopy, whereby light from laser ablation is collected in an optical fiber bundle. Different branches are fed to different spectrometers. One branch may direct a first portion of the light to a broadband spectrometer; another branch may direct a second portion of the light to a high dispersion spectrometer; one or more optics may be used.

In the field of light scattering spectroscopy, US 2003/0232445 A1 discloses systems and methods for determining the physical properties of a structured superficial material layer. With regard to detection, light captured by different fibers is projected onto separate areas of a detector.

Advantages of LIBS, and laser-based optical emission spectroscopy in general, include a non-contact analysis, which is performed at a distance from the sample of, e.g., 100 mm, 200 mm or 500 mm and is free of ionizing radiation. Exemplary fields of application of one of the LIBS-based material identification methods disclosed herein include the analysis of homogeneous and heterogeneous samples at a stationary facility or the analysis of passing samples, for example (on-line) metal analytics of samples transported on a conveyor belt. Material identification can therefore be used as a preparatory step in material sorting. The fast evaluability of the detected spectra can allow feed speeds of several m/s for conveyor belt systems, for example. Due to the contact-free analysis, LIBS systems can be configured to be insensitive and error-resistant with regard to industrial operating environments.

In general, the present disclosure is directed to improving, at least in part, one or more aspects of known LIBS-based systems. One aspect of the present disclosure relates to the object to enable the use of LIBS with easy handling of samples. In particular, a fast and reliable analysis of samples with structured undefined (and, thus, unknown) surface profile is essential for the integration of LIBS into industrial workflows. A further aspect of this disclosure relates to the object to provide sufficiently strong detection signals in the context of LIBS, in particular also when analyzing samples with a structured undefined surface profile. A further aspect of this disclosure relates to the object to provide an optical system, in particular for LIBS, which overcomes the disadvantages of the prior art, in particular with regard to samples with a structured undefined surface profile. A further aspect of this disclosure relates to the object to provide a light guiding system for a LIBS system whereby the light guiding system enables simple forwarding of plasma light to an optical spectrometer.

### SUMMARY

At least some of these objects may be addressed by a spectrometer system described herein.

In an aspect, a spectrometer system for laser-induced plasma spectral analysis comprises a laser beam source for emitting a laser beam, in particular a pulsed laser beam, and a focusing optics for focusing the laser beam onto a sample. Depending on the laser parameters of the laser beam and a material of the sample, a plasma excitation area is formed along the beam axis in such a manner that a surface of the sample located in the plasma excitation area leads to the formation of a laser-induced plasma. Furthermore, the spectrometer system comprises a detection unit for detecting plasma light that is emitted from the laser-induced plasma. The detection unit comprises an objective mount and a plurality of objectives mounted by the objective mount. A detection cone is associated with each of the objectives, which forms a plasma detection region in an overlap region with the laser beam, so that when the laser-induced plasma is formed in one of the plasma detection regions, a measurement portion of the plasma light can be detected by the corresponding one of the objectives. The plasma detection regions jointly form a viewing region of the detection unit. In particular, the viewing region is arranged in the direction of propagation of the laser beam along the beam axis in the region of the plasma excitation area. Furthermore, the spectrometer system comprises a sample vessel (e.g., a sample plate with a round or rectangular shape) with a sample vessel bottom surface on which the sample can be positioned (e.g., for a measurement process for spectral analysis), a sample vessel support and an optical spectrometer for spectral analysis of the measurement portions of the plasma light detected by the detection unit. The sample vessel support is configured to move the sample vessel (e.g., the sample plate) so that a plurality of sections of the surface of the sample can be positioned in the plasma excitation area (e.g., for the measurement process for spectral analysis).

In some embodiments of the spectrometer system, the sample vessel support may be configured to affect a relative movement between the sample vessel and the beam axis, during which relative movement the viewing region is moved at a distance over the sample vessel bottom surface along a scanning trajectory, in particular, a circular, spiral, linear or grid-shaped scanning trajectory. Optionally, the sample vessel support may comprise a rotation drive, a swivel drive, and/or a linear drive to perform the relative movement.

In some embodiments, the sample vessel support may comprise a rotation drive that is configured to drive a rotational movement of the sample vessel about an axis of rotation, the axis of rotation running in particular at an angle in the range from 0° to 80° with respect to the beam axis. The sample vessel support may also comprise a swivel drive, which is configured to move the axis of rotation along a circular path in space, and/or a linear drive, which is configured to move the axis of rotation along an axis in space.

In some embodiments of the spectrometer system, the sample vessel support may comprise two linear drives which are configured to move the sample vessel in a plane in space. Alternatively or additionally, the sample vessel may have a two-dimensional extension and the beam axis may extend at an angle in the range from 0° to 80° to a normal direction of the two-dimensional extension of the sample vessel.

In some embodiments, the spectrometer system may also comprise a deflecting mirror, wherein the deflecting mirror is configured to deflect the laser beam between the focusing optics and the sample vessel, in particular, by 90°. The detection unit is preferably arranged between the deflecting mirror and the sample vessel.

In some embodiments of the spectrometer system, the objectives may be arranged and aligned in the objective mount such that the plasma detection regions are offset along the beam axis and jointly form the viewing region of the detection unit. Alternatively or additionally, the plasma detection regions may partially overlap along the beam axis, merge into one another or be spaced apart from one another, and/or extend along the beam axis over 0.1 mm to 15 mm (for example 0.1 mm to 10 mm) and/or over 1/10 to ¼ of the viewing region.

In some embodiments of the spectrometer system, the objectives may be arranged and aligned in the objective mount such that the detection cones form a common plasma detection region in an overlap area with the laser beam, from which, in the case of a plasma being in the plasma detection region, a measurement portion of the plasma light can be detected by each of the objectives. Alternatively or additionally, each of the detection cones may extend along an observation axis that extends at an observation angle in the range from 0° to 90° with respect to the beam axis. In particular, the observation axes of the objectives may lie on a conical surface around the beam axis.

In some embodiments, the objectives may be arranged azimuthally spaced around the beam axis. The objectives may be arranged and aligned in the objective mount in such a manner that the detection cones can detect measurement portions of the plasma light of a plasma emitted at different solid angles.

In some embodiments, the objective mount may comprise a mount plate in which a plurality of objective mount openings for receiving the objectives and an optical passage opening for the laser beam (205) are provided. The objective mount openings may be arranged around the optical passage opening. Furthermore, the objectives may be arranged azimuthally spaced around the beam axis, in particular, azimuthally equally distributed around the beam axis (205A). For example, the detection unit may comprise two to 25, in particular four, objectives.

In some embodiments, the spectrometer system may further comprise a support frame, to which the focusing optics, the sample vessel support, and optionally the optical spectrometer are mounted. The objective mount may have a mount plate mounted to the support frame or formed as part of the support frame, at which the objectives are mounted and in which an optical passage opening for the laser beam is provided. In particular, the beam axis may extend orthogonally to the mounting plate.

In some embodiments, the spectrometer system may further comprise an optical light guiding system that is configured to forward measurement portions of the plasma light detected by the detection unit to the optical spectrometer and may comprise a plurality of optical inputs and an optical output. Each of the optical inputs is optically associated with one of the objectives and is configured to receive the measurement portion detected with the associated objective, and the optical output is configured to couple measurement portions detected with the objectives into the optical spectrometer.

In particular, at least one of the objectives may be configured and arranged in the objective mount in such a manner that a measurement portion of the plasma light, which is detected in the detection cone of the objective, is imaged onto the optical input associated with the objective. Furthermore, a beam axis may be assigned to each of the measurement portions emerging from the optical light guiding system, whereby the beam axes extend parallel to each other or do not extend under an angle of up to 1° or up to 3° with respect to each other.

In some embodiments of the spectrometer system, the optical spectrometer may comprise an input aperture, in particular an input slit, a dispersive optical element, in particular a grating, prism or grating prism, and a detector. The measurement portions may be coupled into the optical spectrometer through the input aperture and guided to the detector with spectral resolution via the dispersive optical element in order to output a spectral distribution associated with the objectives of the detection unit.

In general, the tips of the detection cones of the detection unit are located shortly behind the laser beam axis, wherein the detection cones “embrace” a possible plasma in the plasma detection region. The objectives can, e.g., be arranged and aligned in the objective mount in such a manner that the plasma detection regions are offset along the beam axis and form an elongated viewing region along the beam axis.

In general, the viewing region of the detection unit is a region along the beam axis from which the detection unit can detect plasma light in the form of measurement portions of individual objectives. In particular, the detection unit may comprise two to 25, for example four, five, eight, nine or 15 objectives.

In a further aspect, a spectrometer system for spectral analysis of a plasma light emitted from a laser-induced plasma comprises a laser beam source for emitting a laser beam, in particular a pulsed laser beam, wherein the plasma is generated on a surface of a sample with the laser beam propagating along a beam axis. Furthermore, the spectrometer system comprises focusing optics for focusing the laser beam onto the surface of the sample, a detection unit as disclosed herein, and an optical spectrometer for spectral analysis of a plasma light detected by the detection unit. Plasma detection regions of the detection unit are arranged in a section along the beam axis. Furthermore, the laser beam source and the focusing optics are configured such that a plasma is generated when the surface of the sample is positioned in each of the plasma detection regions. For example, beam parameters of the laser beam, including in particular the pulse duration and pulse energy of a pulsed laser beam, can be set or adjusted accordingly depending on the material of the sample.

In some embodiments, the plasma detection regions can partially overlap along the beam axis, merge into one another or be spaced apart from one another. Alternatively or additionally, the plasma detection regions can each extend along the beam axis over 0.1 mm to 10 mm or over 1/10 to ¼ of the viewing region. Alternatively or additionally, the objective mount can provide an optical passage opening through which the beam axis extends, wherein a position of the beam axis can be set in particular centrally in the optical passage opening. The objective mount in particular can have a mounting plate in which there are provided several objective mounting openings, which hold the objectives, and the optical passage opening for the laser beam. The objective mount openings can be arranged around the optical passage opening, and in particular distributed azimuthally around the optical passage opening. The objective mounting openings can be configured as passage openings or recesses, wherein apertures of the objectives of the detection unit for light pick-up can generally be arranged on one side of the mounting plate and light outputs of the objectives for coupling light into the light guiding system can be arranged on the other side.

In some embodiments, each of the detection cones (starting from the aperture of an associated objective) may extend along an observation axis, which extends at an observation angle in the range from about 0° to about 90° to the beam axis. The observation angles can in particular be the same, deviate from each other by no more than 3° or be distributed in an angular range of 45°. In particular, the objective mount can have a mounting plate in which an optical passage opening for the laser beam is provided, with the beam axis extending orthogonal with respect to the mounting plate. At least one of the detection cones can extend (starting from the aperture of an associated objective) along an observation axis, which extends at an observation angle in a range from ca. 0° to ca. 90°, in particular in a range from ca. 3° to ca. 60°, for example in a range from ca. 5° to ca. 25°, with respect to the beam axis.

In some embodiments, the objectives can be arranged azimuthally (in particular azimuthally with respect to the beam axis) spaced around the beam axis. The objectives can be arranged in particular azimuthally equally distributed around the beam axis. In other words, observation axes of the objectives can extend from the respective center of the aperture of an objective in the direction of the beam axis and accordingly define planes that extend through the beam axis and the respective observation axis. Each of the planes can be assigned a specific azimuthal angle in relation to the beam axis. With four azimuthally equally distributed objectives, the azimuthal angles of neighboring objectives differ by 90°, for example.

In some embodiments, the detection unit may further comprise an optical light guiding system having a plurality of optical inputs and an optical output. Each of the optical inputs may be optically connected to one of the objectives and configured to receive the measurement portion detected by the associated objective. The optical output can be configured to emit the measurement portions captured by the objectives. In other words, the optical output of the light guiding system can be configured as a common functional output for emitting the measurement portions captured by the objectives.

In some embodiments, the optical light guiding system may comprise a plurality of optical fibers. A respective light entry surface of one of the optical fibers can form one of the optical inputs and the objective associated with the optical input can be configured and arranged (in particular, aligned) to image the plasma detection region of the associated objective onto the light entry surface. The light exit surfaces of the optical fibers can form the optical output, whereby the light exit surfaces can be arranged in a row, in particular adjacent to one another or spaced apart. Furthermore, the light-emitting surfaces can be arranged in a row, in particular, according to the sequence of the plasma detection regions in the viewing region. In some embodiments, the optical fibers can be arrayed linearly on the output side, in particular for alignment along an input slit of an optical spectrometer in which, for example, spectral splitting of the plasma light for spectral analysis of a plasma light detected by the detection unit is performed. In particular, a parallel fiber orientation can be present on the output side for the output of the measurement portions in a common direction.

In some further embodiments, a light guiding zone may have a diameter, e.g., in the range from about 100 μm to about 1,000 μm or more, in particular, in the range from about 100 μm to about 300 μm, in the range from about 150 μm to about 250 μm or in the range from about 750 μm to about 850 μm.

In some embodiments of the spectrometer, the spectrometer may comprise an optical light guiding system, which is configured to forward measurement portions of the plasma light detected by the detection unit to the optical spectrometer and comprises a plurality of optical inputs and an optical output. Each of the optical inputs can be optically assigned to one of the objectives and configured to receive the measurement portion detected with the associated objective. The optical output can be configured to couple measurement portions captured with the objectives into the optical spectrometer. In particular, at least one of the objectives can be configured and arranged in the objective mount in such a way that a measurement portion of the plasma light, which is detected in the detection cone of the objective, is imaged onto the optical input assigned to the objective.

In some embodiments, a beam axis may be associated with each of the measurement portions emerging from the optical light guiding system, and the beam axes may be parallel to each other or run no more than at an angle of up to about 1° or up to about 3° with respect to each other.

In some embodiments, the optical spectrometer may comprise an input aperture, in particular an input slit, a dispersive optical element, in particular a grating, prism or grating prism, and a detector, wherein the measurement portions can be coupled into the optical spectrometer through the input aperture and can be guided to the detector via the dispersive optical element in a spectrally resolved manner in order to output a spectral distribution associated with the objectives of the detection unit.

Examples of samples/materials to be examined in line with the invention include homogeneous and inhomogeneous materials, which are characterized in particular by a non-smooth, non-uniform spatial surface profile. Possible samples/materials to be examined include solids, powders or granules such as metals, glass, sand, salt, minerals, slag, rock, flour, sugar, (agricultural) soil samples, gypsum, clay, lime, marl, cement, coal, coke, ore, emulsions, slurries and, in particular, also thick/viscous samples such as melts, e.g., of glass, aluminum, iron and pig iron, salt, etc.

In the context of the tasks disclosed herein, a detectable volume extends from the objective apparatus (generally, an objective comprises one or more focusing optical elements, such as a focusing lens or a focusing mirror, and optionally defocusing optical elements, such as a defocusing lens or a defocusing mirror, mounted in a housing) toward the plasma to be detected. The volume detectable by an objective is referred to herein as a detection cone (and is also known as the “light cone” of an objective). In the context of the present disclosure, a detection cone thus generally corresponds to a volume from which light can be detected by an objective and forwarded to an optical spectrometer. In the case of a round objective aperture, the detectable volume is conical in the narrower sense, i.e., with a circular cross-section. In the context of the present disclosure, a detection cone also comprises a cone geometry that deviates from rotational symmetry and, thus, does not have a round cross-sectional geometry. The axis of the detection cone is also referred to herein as the observation axis and generally defines an observation direction of the objective.

In LIBS, an overlap area of the detection cone with the laser beam represents a plasma detection region of an objective. The detection cone usually extends over the plasma, which is generated by the laser beam in the area of the beam axis of the laser beam, and, thus, extends beyond the beam axis in order to have a cross-section in the area of the plasma that is adapted to the size of the plasma for the detection of an as large as possible measurement portion of the plasma light.

In other words, each objective can detect plasma light from a plasma at a specified solid angle in relation to a focal point of the objective. A prerequisite is that the plasma is located in the detection cone/light cone of the objective that defines the solid angle of the detectable light, preferably at the pointed end of the detection cone/light cone. Possible dimensions of the cross-section of the detection cone at the position of the plasma to be detected can be such that, at the position of the plasma to be detected, there results a length in the direction of propagation of the detection cone that is, e.g., in the range from 10% to 25% of the length of the viewing region to be provided by the detection unit (in the direction of propagation) and that can, for example, be in the range from 0.1 mm to 10 mm or, e.g., up to 15 mm.

In the context of the LIBS disclosed herein, samples are examined that have a three-dimensional profile on the side of the incident laser beam, so that—when performing the measurement on different surface areas—a surface of the sample in the direction of the beam axis of the laser beam is not at a fixed location onto which the laser beam could be focused. The three-dimensional shape of the sample causes the plasma also not be formed at a fixed location in the direction of the beam axis, but that it can vary in its position along the beam axis of the laser beam. The extent of the possible variation in the location of a plasma that can be used for spectral analysis (also referred to herein as the “laser induced plasma excitation area”) depends—in addition to the course of the surface of the sample in the direction of the beam axis and the coupling ability (absorption) of the material—on the focusing of the laser beam, and, in particular, on the intensity curve of the laser beam in the focus area. With corresponding beam parameters (focus diameter and focus length) and laser parameters (laser power, laser pulse energy, laser pulse duration . . . ), the possible plasma excitation area in the direction of the beam axis can extend over fractions of a millimeter up to several millimeters (e.g., 2 mm to 4 mm) or even up to several 10 cm, e.g., up to 20 cm.

In some embodiments, an implementation of the multifocal concept can have the following advantages. With regard to the detection of plasma light, there is significantly increased a depth of field, here in the sense of a detectable depth range along the laser propagation direction, given by the arrangement of the objectives. This enables or facilitates the examination of samples with a non-smooth surface shape. In this way, the detection of plasma light across the excitation range is independent of any mechanical movement of the detection unit or the sample in the direction of the laser beam. This results in a greater tolerance with regard to the position of the sample/sample surface and, thus, the surface geometry of the sample. Furthermore, sample preparation such as smooth spreading a powder or smooth pressing a surface can be omitted.

When designing a detection device, the optical design of a single objective can be used to increase the depth of field. A greater depth of field caused by the optical design of a single objective can result in an increase in the distance to the sample, which reduces the amount of light detected by the objective (reduction in the solid angle/light cone of the objective). To compensate for this, an objective with a larger aperture (larger light cone) can be used.

In contrast to such designs/optical configurations of objectives, the described multifocal concept achieves a depth of field extending over a larger range through the use of several objectives with offset plasma detection regions. The offset plasma detection regions result in that plasma light can be detected from a greater depth range. It is not necessary to change the distance so that the amount of light detected remains the same.

Due to, among other things, a greater tolerance with respect to the location at which a plasma to be detected is generated, the multifocal detection approach proposed herein can be used to perform an essentially sample preparation-free analysis of (homogeneous and heterogeneous) samples at a stationary device or an analysis of passing samples.

In some embodiments of the multifocal concept—even with a more structured three-dimensional surface shape of a sample—a spectrometric examination can be carried out without or, if at all, with only a rudimentary height adjustment preceding the measuring process.

In some embodiments, an implementation of the multilateral concept can have the following advantages. Simultaneous observation of a plasma can take place from different observation directions, with the sum of all “observation directions” forming a common spectral optical (output) measurement signal as a result. Even if one of the observation directions is blocked due to the surface shape of the sample or another obstacle, a sufficient measurement portion can still be available for the spectral analysis.

In some embodiments of the optical light guiding system, the combination of n>1 fibers (e.g., n=2, 3, 4 . . . 10 . . . 15) on one (functional) fiber output can allow an advantageous feeding of several objectives into an optical spectrometer. Advantages of such an n-fold observation are given when implementing the multifocal concept and the multilateral concept.

### BRIEF DESCRIPTION OF THE DRAWING

Herein, there are disclosed concepts that allow to improve at least some aspects of the prior art. In particular, further features and their usefulness result from the following description of embodiments with reference to the drawings. The drawings show:

FIG. 1—a schematic overview of a LIBS system;

FIG. 2—a sketch to illustrate the multifocal concept;

FIG. 3—a perspective view of an exemplary LIBS measuring head;

FIGS. 4A and 4B—a top view of a first exemplary mounting plate and a perspective view of a detection unit (multifocal concept);

FIGS. 5A and 5B—a top view of a second exemplary mounting plate and a perspective view of a detection unit (multifocal concept);

FIGS. 6A and 6B—a top view of an exemplary mounting plate and a perspective view of a detection unit (multilateral concept);

FIG. 7A to 7E—schematic sketches to illustrate an exemplary light guiding system comprising several optical fibers;

FIG. 8A to 8C—schematic sketches to illustrate the coupling of the light guiding system from FIG. 6 into an optical spectrometer;

FIGS. 9A and 9B—an illustration of exemplary spectral intensity curves with associated measurement constellation (multifocal concept, plasma in a plasma detection region);

FIGS. 10A and 10B—an illustration of exemplary spectral intensity curves with associated measurement constellation (multifocal concept, plasma within two plasma detection regions);

FIGS. 11A and 11B—an illustration of exemplary spectral intensity curves with associated measurement constellation (multilateral concept, without shading);

FIGS. 12A and 12B—an illustration of exemplary spectral intensity curves with associated measurement constellation (multilateral concept, with shading);

FIG. 13A to 13F—schematic illustrations explaining a stationary spectrometer with a sample vessel that can be positioned using, for example, the multifocal concept; and

FIG. 14A to 14C—two flow diagrams and a sketch explaining exemplary measurement processes.

### DETAILED DESCRIPTION OF THE PREFERRED EMBODIMENTS

The aspects described herein are partly based on the realization that the use of several objectives in combination with an optical spectrometer enables an extension of the detectable solid angle portion in LIBS. If the objectives are arranged and aligned accordingly, a detected depth of field range can be enlarged, e.g., along the beam axis (multifocal concept). Alternatively or additionally, the portion of the detected plasma light emitted from a plasma at one location can also be increased (multilateral concept).

The inventors have recognized that using the concepts proposed herein, it is possible to detect plasma light over a viewing region along the beam axis that is longer than that provided by a single objective under comparable conditions. In the viewing region, the detection unit can provide a depth of field along an excitation range provided by the laser, that depth of field results in a tolerance with regard to the position of the sample and, thus, the position of the plasma on the surface of the sample. Instead of height compensation according to the prior art by mechanically moving the detection unit or the sample (or mechanically adjusting the sample surface to a focal point/point-shaped excitation area), the multifocal concept uses several plasma detection regions that are arranged along the excitation area provided on the laser side.

Herein, a plasma detection range is determined by an observation axis and a solid angle, which are assigned to an objective. In order to provide in particular for several objectives comparable conditions for detecting plasma light (or, e.g., in the sense of a symmetrically implemented setup of a detection unit), the observation axes of the different objectives can be directed towards the beam axis at essentially the same observation angle, albeit offset in the direction of the beam axis in the case of the multifocal concept.

By the depth of field provided by the multifocal concept disclosed hereinalong the beam axis, plasma light can be detected for sections of the surface profile of the sample in the correspondingly covered depth of field range (without repositioning or controlling the spectrometer system), which plasma light can then be measured spectrally resolved in a (common) optical spectrometer. The detectable signal contribution can thus be increased, which means that the measurement process can take less time than if only one objective is used for detection in a plasma detection region/at one position in the direction of propagation.

The inventors have also noticed that when using a single objective, there can be at least temporary spatial shadowing of a detection cone and the plasma to be detected in it. The shadowing is caused, for example, by the surface profile of the sample in space as it exists in the vicinity of the plasma. The inventors have then realized that it is possible to detect plasma light emitted in different directions with the aid of several objectives and to analyze the plasma light with a (common) optical spectrometer. Thereby, the influence of shadowing effects can be attenuated.

In order to obtain comparable signal information from each of the objectives, in one embodiment the observation angles of the objectives can be as identical as possible (e.g. essentially identical) in relation to the direction of propagation of the laser beam. In the case of a spatially extended plasma, this can also prevent different plasma regions with possibly different spectral components from being combined into one signal.

The inventors have also recognized that, in an advantageous embodiment, a light guiding fiber bundle can be used to combine the measurement portions of the various objectives and to couple them into a optical spectrometer in common—at a functional fiber output of the light guiding fiber bundle—through a slit of the optical spectrometer for spectral analysis. For this, the light guiding fibers each pick up the measurement portion of one of the objectives at one end during operation. At the other end, the light guiding fibers are brought together and mounted in an optical connector and form the common functional fiber output. Preferably, the light guiding fibers emit the measurement portions at least in large parts to the same zones of the detector in order to achieve the highest possible signal strengths. For example, the light guiding fibers can output their measurement portions at the functional fiber output in the same direction. In some embodiments, the ends of the optical fibers can for this be aligned in the same direction, in particular extend as parallel as possible. Furthermore, the light guiding fibers can, for example, be arrayed linearly and aligned along the slit when mounted. In order to achieve the location of the functional fiber output as localized as possible and, thus, the coupling of the measurement portions into the optical spectrometer, the light guiding fibers in the optical connector can run close to each other, preferably directly next to each other.

In some embodiments, the ends of the light guiding fibers can extend in the optical connector at angles with respect to one another, wherein the angles being matched to the geometry of the spectrometer (optical paths in the spectrometer) in such a manner that the measurement portions of the objectives are additionally placed on top of one another as far as possible in their maxima at the detector of the optical spectrometer—e.g., in the direction of the linear array.

The various inventive concepts are explained below by way of example in conjunction with the figures.

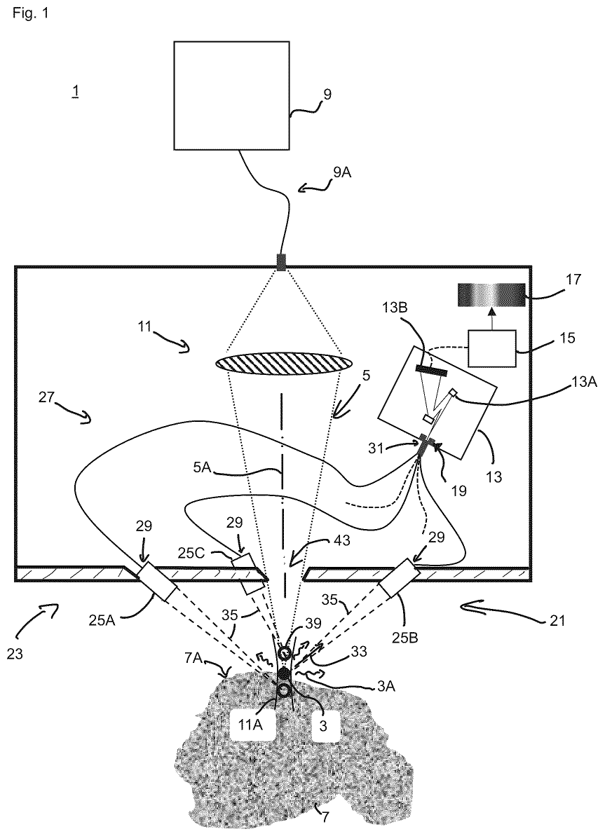

FIG. 1 shows a schematic overview of a spectrometer system 1 (LIBS system) for spectral analysis of a plasma light 3A emitted from a laser-induced plasma 3 (schematically indicated as a filled circle). Detectable plasma light 3A lies, for example, in the wavelength range of UV light, visible light, near infrared light and/or infrared light; in particular, plasma light to be detected can lie in the spectral range from ca. 190 nm to ca. 920 nm. In LIBS, the plasma 3 is generated with a laser beam 5 on a surface 7A of a sample 7.

To generate the, e.g., pulsed, laser beam 5, the spectrometer system 1 comprises a laser beam source 9. The laser beam source 9 is configured to provide the laser beam parameters required for plasma generation; exemplary laser beam parameters for the material analysis of minerals, salts, FE and NE metals, etc. include, for example, laser pulse energies in the range from <1 mJ to >100 mJ, laser pulse durations in the range from <Ins to >100 ns and a central laser wavelength, e.g., in the infrared (IR) range (e.g. around 1064 nm), in the ultraviolet (UV) range or in a wavelength range in between or in several wavelength ranges, i.e., e.g., in a combination of several wavelengths, as well as fixed or adjustable repetition rates or laser pulse burst settings. The laser beam 5 is fed, e.g., via a light guiding fiber 9A (that is optionally optically active, such as spectrally broadening or amplifying) to a focusing optic 11, and is focused onto the surface 7A of the sample 7. The focusing optics 11 can be, configured in particular as a laser head component with a focusing function, such as an active laser component with a focusing function that acts in particular on the spectrum or the pulse duration or the pulse energy. The propagation of the laser beam 5 between the focusing optics 11 and the sample 7 extends along a beam axis 5A. Exemplary focus diameters (1/e² beam diameter in the beam waist) are in the range from <50 μm to >250 μm and exemplary focus lengths (e.g., doubled Rayleigh length) are in the range from <5 mm to >1,000 mm.

Laser parameters can in particular be set/selected in such a manner that a range in which plasma generation can take place (also referred to as a possible excitation area) extends, for example, over a length in the range from ca. 0.2 mm to ca. 50 mm, for example over a length of 2 mm, 5 mm, 20 mm, 200 mm or 500 mm, along the beam axis 5A.

FIG. 1 schematically shows a focus zone 11A elongated along the beam axis 5A, as it is formed in the area of the surface 7A of the sample 7. The plasma 3 forms on the surface of the sample 7A due to the interaction of the laser radiation with the material. In LIBS, the usual dimensions (average diameter) of a plasma 3 are in the range of, e.g., 0.1 mm to 5 mm (depending on sample material and laser parameters).

The spectrometer system 1 also comprises an optical spectrometer 13 for spectral analysis of the plasma light 3A. The optical spectrometer 13 is shown in FIG. 1 exemplarily as a grating spectrometer. In general, the spectrometer 13 comprises at least one dispersive element 13A, e.g., a grating, a prism or a grating prism, and a pixel-based detector 13B, onto which the plasma light impinges in a spectrally expanded form. Spectral components of the plasma light 3A to be analyzed are assigned to the pixels of the detector 13B. The detector 13B outputs intensity values of the irradiated pixels to an evaluation unit 15, usually a computer with a processor and a memory. The evaluation unit 15 outputs a measured spectral distribution 17 and compares it, for example, with stored comparison spectra in order to associate the elements contributing to the plasma light 3A with the plasma light 3A and, thus, with the sample 3 being analyzed and to output the associated elements as the result of the spectral analysis.

In the spectrometer 13, a (spectral-dependent) beam input for the plasma light to be analyzed is defined by an input aperture 19, usually an input slit 19A.

The spectrometer system 1 further comprises a detection unit 21 with an objective mount 23 and a plurality of objectives 25A, 25B, 25C, which are mounted by the objective mount 23. By way of example, three objectives are shown in the figures, two in the image plane and one behind it. The concepts disclosed herein are implemented with more than one objective in the objective mount 23. The number of objectives used can be selected depending on spatial and optical parameters as well as parameters of the material of the sample to be examined; the number lies, for example, in the range from 2 to 20, for example, 4, 5, 8, 9 or 15 objectives.

The spectrometer system 1, in particular the detection unit 21, further comprises an optical light guiding system 27 that optically connects the objectives 25A, 25B, 25C to the spectrometer 13. The light guiding system 27 provides several optical inputs 29, each of which is optically associated with one of the objectives 25A, 25B, 25C, and an optical output 31 (common to the objectives, functional), which is optically associated with the input aperture 19.

Each of the objectives 25A, 25B, 25C is set up to detect a measurement portion 33 of the plasma light 3A and comprises at least one focusing optical element (such as a converging lens usually arranged in a light-tight housing or a concave mirror). A detection cone 35 is associated with each of the objectives 25A, 25B, 25C. The beam axis 5A runs through the detection cones 35, with the detection cones 35 having a set minimum size in the area of the laser beam 5. Each of the detection cones 35 comprises a plasma detection region 39 in an overlap region with the laser beam 5, which is associated with the corresponding objective 25A, 25B, 25C. For example, the detection cones 35 have a length from an input aperture of an objective to the laser beam in the range from 100 mm to 500 mm. In FIG. 1, the plasma 3 is generated exemplarily in the plasma detection region 39 of the objective 25B, so that the associated measurement portion 33 of the plasma light 3A is detected by the objective 25B and imaged onto the associated optical input 29 of the light guiding system 27. Measurement portions 33 detected by one or more objectives are guided by the optical light guiding system 27 to the common optical output 31 and coupled through the input aperture 19 into the optical spectrometer 13 for spectral analysis.

FIG. 1 shows exemplarily three objectives 25A, 25B, 25C, which are arranged (azimuthally distributed) around the beam axis 5A. The objectives 25A and 25B are located on opposite sides of the beam axis 5A and are therefore directed at the beam axis 5A from opposite sides. The objective 25C is directed towards the beam axis 5A from behind. A further objective (not shown in FIG. 1) can, for example, be directed at the beam axis 5A from the front or be directed at the focus zone 11A along the beam axis 5A with the aid of a beam splitter. For illustration, the detection cones 35 are shown in FIG. 1 as dashed lines tapering towards the beam axis 5A, wherein the focus zone 11A, the plasma 3 and the plasma detection regions 39 are shown oversized in comparison to the detection cones 35 for illustration.

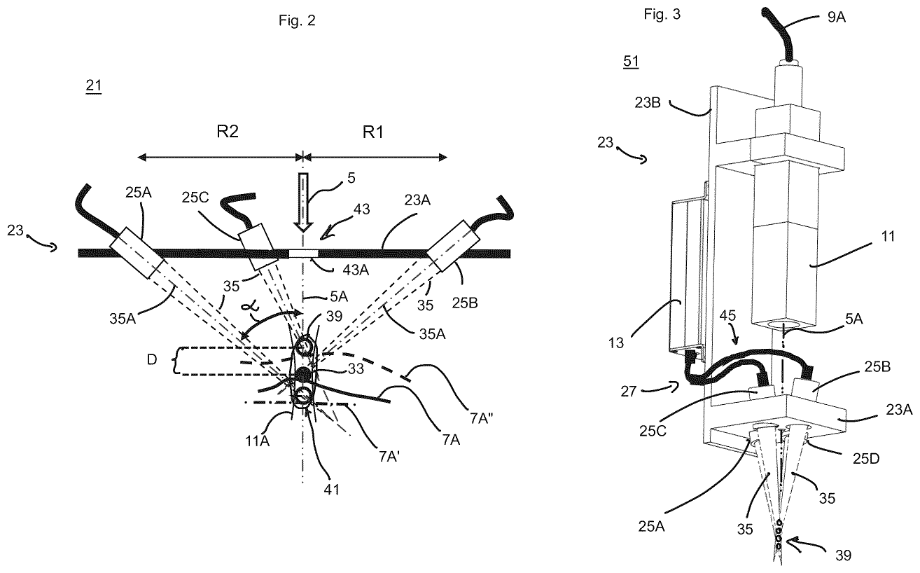

FIG. 2 shows a mounting plate 23A of the detection unit 21 of the LIBS system to illustrate the arrangement and alignment of the objectives 25A, 25B, 25C. For stationary mounting of the objectives, the mounting plate 23A has objective mounting openings for receiving the objectives 25A, 25B, 25C. The objective mounting openings are each arranged at a radial distance from the beam axis 5A and are configured for an oblique alignment of the objectives 25A, 25B, 25C with respect to the beam axis 5A. Observation axes 35A of the objectives 25A, 25B, 25C are shown to illustrate the oblique alignment. In the example shown, the observation axes 35A run at an observation angle α to the beam axis 5A.

For implementation of the multifocal concept, the objectives 25A, 25B, 25C are fixed in the mounting plate 23A (generally arranged and aligned in the mount 23) such that the plasma detection regions 39 are offset along the beam axis 5A. In particular, for comparable observation angles α, the offset in the direction of the beam axis 5A can be achieved by varying the radial distance of the objectives 25A, 25B, 25C from the beam axis 5A (optionally with varying insertion). As an example, different radial distances R1 and R2 for the objectives 25A and 25B are indicated in FIG. 2. Alternatively (optionally with a comparable radial spacing), the observation angle of at least some of the objectives can be adapted to the desired offset of the plasma detection regions 39 in the direction of the beam axis 5A (see, for example, FIG. 5B). Mixed types in the configuration are also possible.

In general, the observation angle α can be in the range from 0° (via beam splitter along the laser beam) to 90° (observation orthogonal to the laser beam). The observation angles α shown exemplarily in the context of the disclosure are in the range from 3° to 60°, for example, in the range from 5° to 25°. The observation axes 35A of neighboring objectives 25A, 25B, 25C approach the beam axis 5A from different azimuthal directions (azimuthal angle in the plane perpendicular to the beam axis 5A). In the case shown in FIG. 2, the observation angles α are comparable for all objectives and do not deviate from each other by more than, e.g., 5° or 1° (deviation given, e.g., by permitted manufacturing tolerances of the objective mount openings and objectives). However, the radial distances to the beam axis 5A vary in the arrangement shown in FIG. 2. Accordingly, comparable spectra can be received from the plasma detection regions 39 of the different objectives for a sample at different positions of the surface of the sample along the beam axis 5A (corresponding to different measurement constellations in the context of a measurement process), for example from objective 25B in the case of a surface profile according to the solid line (surface 7A of sample 7 from FIG. 1) or from objective 25A in the case of a surface profile according to the dotted line 7A′ or from objective 25C in the case of a surface profile according to the dashed line 7A″.

As indicated in FIG. 2, the plasma detection regions 39 together form a viewing region 41 of the detection unit 21. The viewing region 41 extends along the beam axis 5A in the area of the focus zone 11A.

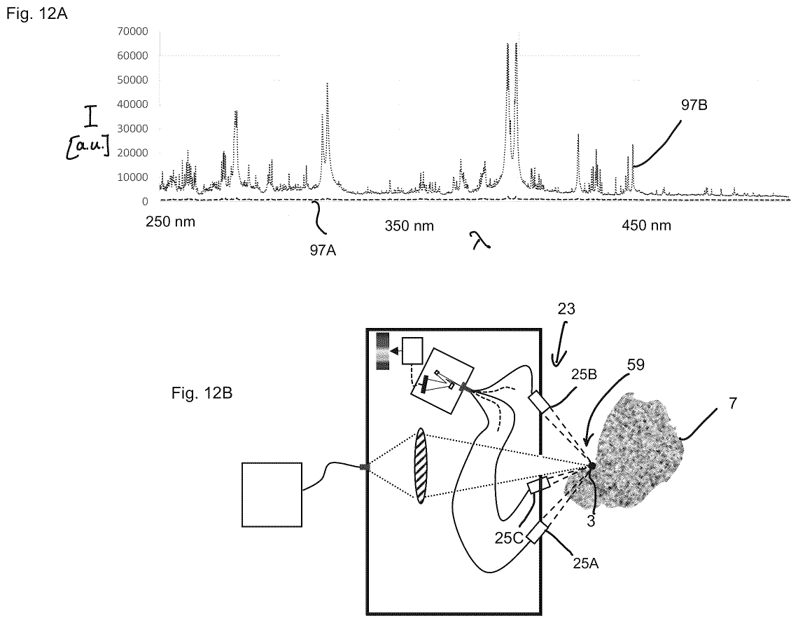

Each of the plasma detection regions 39 is associated a measuring depth along the beam axis 5A. In FIG. 2, the measuring depth corresponds, for example, to a diameter of the circles that illustrate the plasma detection regions 39. For an objective, the measurement depth is a specific characteristic that is given by optical parameters such as the focal length and aperture of the objective as well as by the arrangement and orientation of the objective (e.g., geometric position parameters of the objective with respect to the beam axis 5A—distance and angle). For example, the plasma detection regions 39 along the beam axis 5A can each extend over a measurement depth of ca. 0.1 mm to ca. 15 mm, in particular, over a measurement depth of ca. 0.5 mm to ca. 10 mm or from ca. 0.5 mm to ca. 5 mm. In some embodiments, the plasma detection regions 39 can extend along the beam axis 5A over 1/10 to ¼ of the viewing region 41. In FIG. 2, the plasma detection regions 39 arranged offset along the beam axis 5A in the multifocal concept are spaced exemplarily at a distance D in the order of magnitude of the measuring depth (here ca. twice the diameter of the plasma detection regions 39). Alternatively, the plasma detection regions 39 can be adjacent to each other or partially overlap (for example, in the range of 10% of the measuring depth). In this way, the objectives can detect plasma light from different sections of the viewing region 41 along the beam axis 5A. (In contrast to this, plasma detection regions in the multilateral concept essentially cover the same section along the beam axis 5A, so that the objectives detect plasma light from this same section. See, for example, FIG. 11B with associated description).

Furthermore, FIG. 2 shows an optional protective window 43A, which can be provided in the area of an optical passage opening 43 in the mounting plate 23A in order to be able to direct the laser beam through the mount 23 and past the objectives 25A, 25B, 25C onto the sample 7.

FIG. 3 shows a perspective view of an exemplary LIBS measuring head 51, which is connected to a laser beam source via an optical fiber 9A. The holder 23 of the LIBS measuring head 51 comprises a longitudinal support plate 23B, on the input side of which, there is provided an attachment for the optical fiber 9A and the focusing optics 11 (laser head with beam shaping). The optical spectrometer 13 is also attached to the longitudinal support plate 23B. and the mounting plate 23A is provided for the four objectives 25A, 25B, 25C, 25D (generally an n>1-fold entrance objective). The objectives 25A, 25B, 25C, 25D are set up to detect measurement portions of plasma light from plasma detection regions 39, which are arranged offset to each other along the beam axis 5A, and to feed them to the spectrometer 13 for spectral analysis via the light guiding system 27 (for example, a fiber bundle with n>1 inputs and one functional output—“n-to-1 fiber bundle”). FIG. 3 shows exemplarily two optical fibers 45 of the light guiding system 27, which optically connect the objectives 25B and 25C to the common spectrometer 13. The light guiding system 27 can be used to combine the measurement portions in the spectrometer 13 (or optionally before coupling into the spectrometer 13) for a measurement process.

The n-fold observation of the viewing region with several (four in FIG. 3) objectives allows a significant increase in the depth of field, given by the juxtaposition of the plasma detection regions of the objectives. This makes it possible to efficiently analyze also samples being structured and non-smooth in its surface. Furthermore, the sample is viewed from different angles, which reduces shadowing effects. The received measurement portions are combined at a common output of the light guiding system (sum of all observations) and fed to a common spectral analysis.

An n-to-1 fiber bundle allows several objectives to be fed into one spectrometer, wherein several n-to-1 bundles can be used for feeding into several spectrometers.

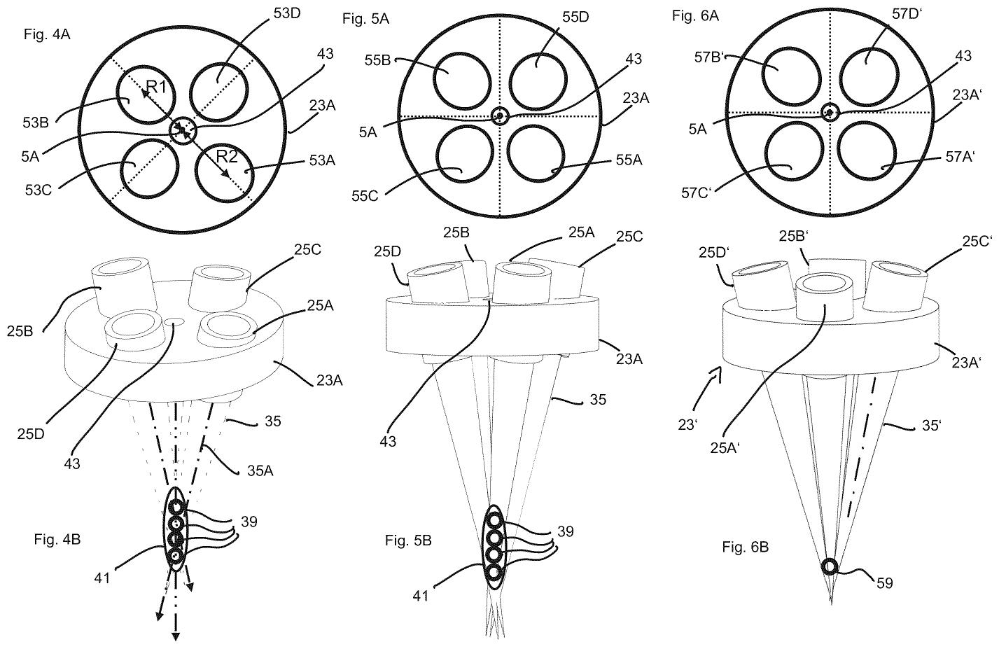

The exemplary implementation of the multifocal concept in the detection unit shown in FIG. 2 is further illustrated in FIGS. 4A and 4B. FIG. 4A shows a top view of the mounting plate 23A. The optical passage opening 43 in the center allows the laser beam to pass through (laser beam axis 5A). Four objective mounting openings 53A, 53B, 53C, 53D are arranged azimuthally around the passage opening 43 with varying radial distances to the beam axis 5A. They are equally distributed azimuthally, so that two objective mount openings are located opposite each other in pairs. In the perspective view of FIG. 4B, four identical objectives 25A, 25B, 25C, 25D are inserted into the objective mount openings 53A, 53B, 53C, 53D. The objectives 25A, 25B, 25C, 25D have been inserted into the objective mount openings 53A, 53B, 53C, 53D differently in extent so that, depending on the radial distance, the associated plasma detection regions 39 are arranged next to each other in the direction of the beam axis and, thus, form the viewing region 41 of the detection unit 21 given by the depth of field.

An alternative implementation of the multifocal concept is illustrated in FIGS. 5A and 5B. The top view of the mounting plate 23A shows four objective mounting openings 55A, 55B, 55C, 55D, which are symmetrically arranged at the same radial distance from the through aperture 43 and equally distributed around it, for example. As indicated in the perspective view of FIG. 5B, the offset of the plasma detection regions 39 in the direction of the beam axis 5A is caused by different observation angles of the objectives 25A, 25B, 25C, 25D used. For example, at a radial distance of 30 mm, the observation angles can be in the range of 3° to 15°, so that the viewing region 41 is formed at a distance of approximately 100 mm from the mounting plate 23A. With different observation angles (and optionally observation heights), the detected spectral distributions can vary with a large-volume plasma. However, particularly in the case of a small-volume plasma, as it is usually generated in LIBS, these differences in the spectral distribution are negligible, because essentially the entire plasma lies in a plasma detection region 39.

An exemplary implementation of the multilateral concept is illustrated in FIGS. 6A and 6B. In the top view of FIG. 6A of an exemplary mounting plate 23A′ of an objective mount 23′, one recognizes four objective mounting openings 57A′, 57B′, 57C′, 57D′ provided in the mounting plate 23A′, similar to FIG. 5A. The objective mount openings 57A′, 57B′, 57C′, 57D′ are arranged symmetrically at the same radial distance from the passage opening 43. In the case of FIG. 6A, they are arranged exemplarily in an equally distributed manner, i.e., they are located opposite each other in pairs. The objective mount also provides an optical passage opening 43 through which the beam axis 5A extends. In particular, a position of the beam axis 5A was placed in the center of the optical passage opening 43.

As shown in FIG. 6B, objectives 25A′, 25B′, 25C′, 25D′ are mounted in the objective mount openings 57A′, 57B′, 57C′, 57D′ of the objective mount 23′. In contrast to the orientation of the objectives 25A, 25B, 25C, 25D in FIG. 5B, in the multilateral concept the objectives 25A′, 25B′, 25C′, 25D′ are directed towards the beam axis at an essentially identical observation angle, so that they form a common plasma detection region 59. A detection cone 35′ is associated with each of the objectives 25A′, 25B′, 25C′, 25D′, whereby the objectives 25A′, 25B′, 25C′, 25D′ are arranged and aligned in the objective mount in such a manner that the detection cones 35′ form a common plasma detection region 59 in an overlap region with the laser beam. I.e., in the case of a plasma present in the plasma detection region 59, each of the four objectives 25A′, 25B′, 25C′, 25D′ can detect a measurement portion of the plasma light, with the detection cones 35′ detecting measurement portions of the plasma light of the plasma emitted at different solid angles. Each of the detection cones 35′ extends along an observation axis 35A′, which extends at an observation angle in the range up to 90° (observation orthogonal to the laser beam) to the beam axis 5A. The observation angles shown exemplarily in the context of the disclosure are in the range from 1° to 60°. The observation angles are essentially the same (within, for example, 1° or 2°, e.g., manufacturing-related tolerance) or may deviate from one another, for example, in order to observe from different directions (observation angle differences of up to 90°, for example, up to 45°).

It can be seen in FIG. 6B that the observation axes 35A′ of adjacent objectives 25A′, 25B′, 25C′, 25D′ are arranged azimuthally spaced around the beam axis. Thereby, the observation axes 35A′ of the objectives 25A′, 25B′, 25C′, 25D′ lie on a, for example, conical surface.

Further explanations of the multilateral concept follow in connection with FIGS. 11A to 12B.

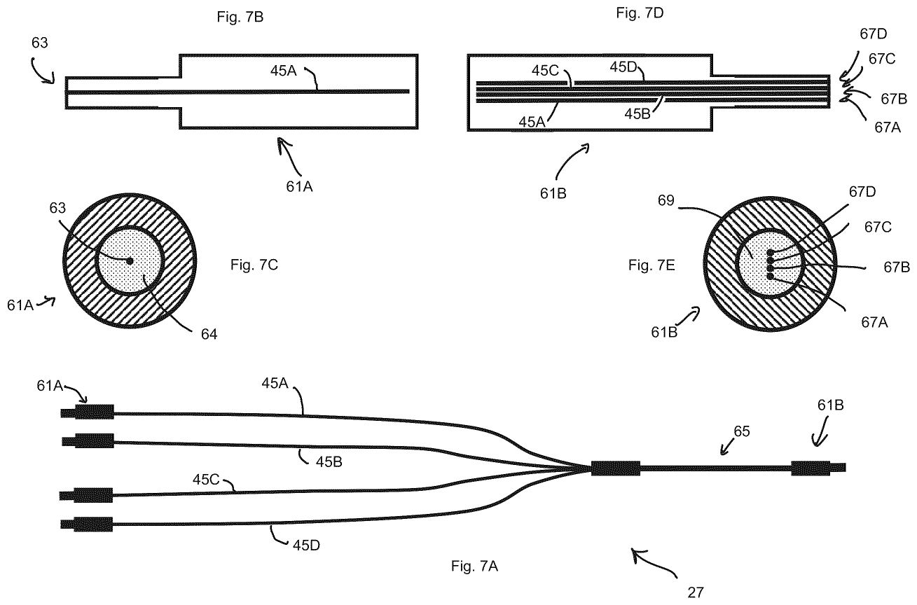

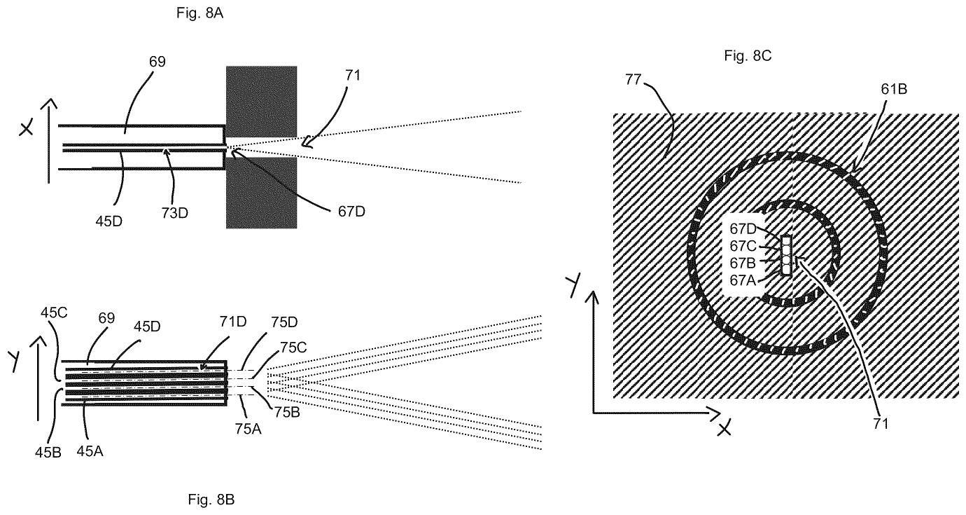

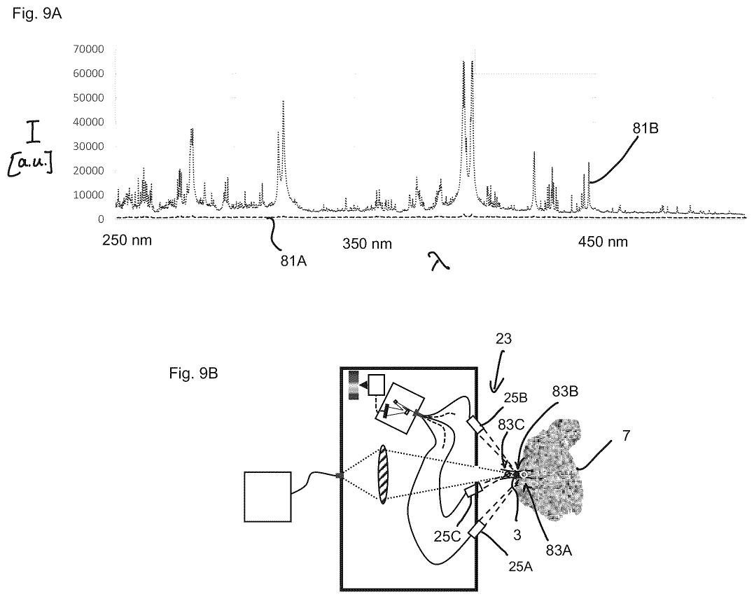

In the spectrometer systems for multifocal and/or multilateral observation proposed herein, a light guiding system is generally used to guide measurement portions of the detected plasma light from the detection unit to the optical spectrometer. Besides the light guiding systems based on several optical fibers explained below in connection with FIGS. 7A to 7E and 8A to 8C, the measurement portions can also be guided from the objectives to the input aperture of the optical spectrometer via a free beam system using, for example, mirrors and lenses. Alternatively, light guiding systems can be based on several optical fibers, for example, which are combined into one fiber on the output side.

The schematic sketches in FIGS. 7A to 7E illustrate an exemplary light guiding system 27 with several optical fibers 45A, 45B, 45C, 45D, which are configured to guide the measurement portions of the detected plasma light to the optical spectrometer in light-guiding areas. Exemplary optical fibers are adapted to the spectral ranges to be guided (UV, VIS, IR, NIR) and can include, for example, the following types of optical fibers: step index fibers, gradient index fibers, hollow-core fibers, photonic crystal fibers as well as single-mode fibers or multi-mode fibers. Diameters of the light-guiding areas are, e.g., in the range from 100 μm to 1,000 μm, in particular in the range around 800 μm. Associated light entry surfaces/light exit surfaces have comparable dimensions. Furthermore, variations in the diameter of a light-guiding area between the light entry surface and the light exit surface are possible, as explained below for an example.

Each of the optical fibers is fixed on the input side in an optical input connector 61A, for example in an SMA connector (FIGS. 7B and 7C). The light-guiding areas of the optical fibers 45A, 45B, 45C, 45D each have a light entry surface 63 on the input side. In FIG. 7C, for example, the light entry surface 63 is shown centered in a rotationally symmetrical ferrule 64 in a front view of the input connector 61A. Each of the light entry surfaces 63 forms one of the optical inputs 29 of the light guiding system 27. The input connector 61A can be mounted on one of the objectives of the detection unit in such a manner that one of the measurement portions is coupled into the light guiding area. For this, the light entry surface 63 is positioned in such a manner that an objective, which detects plasma light emitted from the plasma detection region in the direction of the objective (i.e., propagating in the detection cone), images this light onto the light entry surface 63 so that it can be forwarded by the optical fiber.

As shown in FIG. 7A, the optical fibers 45A, 45B, 45C, 45D can be combined to form a fiber bundle section 65 on the output side.

On the output side, the optical fibers 45A, 45B, 45C, 45D, which are each assigned to an objective in the multifocal concept and in the multilateral concept, are fixed in a (common) output connector 61B (FIGS. 7D and 7E). The light-guiding areas of the optical fibers 45A, 45B, 45C, 45D each have a light-emitting surface 67A, 67B, 67C, 67D on the output side. The light exit surfaces 67A, 67B, 67C, 67D form the optical (functional) output 31 of the light guiding system 27. As shown in FIG. 7E, in the output connector 61B, the optical fibers 45A, 45B, 45C, 45D are fixed in a ferrule 69 running essentially parallel to one another. For example, fiber receiving openings are provided in the ferrule 69, which run parallel to each other and are adapted to the outer diameter of the optical fibers 45A, 45B, 45C, 45D. Preferably, the optical fibers 45A, 45B, 45C, 45D are arranged such that the optical fibers 45A, 45B, 45C, 45D are fixed in the ferrule 69 adjacent to each other or with an intermediate distance of a few percent, e.g., 10%, 20%, 30% or 100%, of a diameter of the optical fibers 45A, 45B, 45C, 45D. As shown in the front view of the output connector 61B in FIG. 7E, the light exit surfaces 67A, 67B, 67C, 67D can, for example, be arranged as an array next to each other (linearly) in order to geometrically adapt the optical output 31 to a slit-shaped input aperture of the optical spectrometer for efficient coupling.

FIGS. 8A to 8C show how the output connector 61B can be mounted at the optical spectrometer 13 for efficient light coupling of the measurement portions. For example, as in FIG. 7E, the light exit surfaces 67A, 67B, 67C, 67D are arrayed linearly and aligned along an inlet slit opening 71 running in Y direction. Accordingly, a position of the coupling in X direction is given by a width of the input slit opening 71. The position of the coupling in Y direction is given by the light exit surfaces 67A, 67B, 67C, 67D lying one above the other in Y direction. The closer the light exit surfaces 67A, 67B, 67C, 67D are to each other, the more the optical paths of the measurement portions overlap in the optical spectrometer and lead to equally localized signal contributions on the detector.

In some embodiments, the order of the light emitting surfaces 67A, 67B, 67C, 67D corresponds to the sequence of the plasma detection regions 39 in the viewing region 41. As a result, the centrally located plasma detection regions 39 are optimally coupled into the optical spectrometer so that the associated measurement portions contribute most efficiently to the spectral analysis. With reference to the examples of the multifocal concept in FIG. 4B and FIG. 5B, the central optical fibers in the output connector can also be used for the central plasma detection regions 39. With reference to the example of the multilateral concept in FIG. 6B, the sum of the measurement portions of all contributing optical fibers is decisive, wherein different optical fibers contribute depending on the surface profile, so that a corresponding sequence will generally have less to no effect.

In a schematic top view of a section through the “uppermost” optical fiber 45D (FIG. 8A), a schematic side view of a section through the four optical fibers 45A, 45B, 45C, 45D (FIG. 8B) and a view of the light exit surfaces 67A, 67B, 67C, 67D of the optical fibers in the mounted state (FIG. 8C), the coupling through an input slit opening 71 into an optical spectrometer is illustrated. FIG. 8A shows the optical fiber 45D mounted in the ferrule 69. The light-guiding area 73D extends inside the optical fiber 45D (schematically indicated), wherein the light-guiding area 73D ends in the light exit area 67D. The measured portion of the detected plasma light emerges from light exit area 67D and passes through the elongated input slit opening 71 (slit width, e.g., 10 μm). A possible beam divergence in X direction due to the slit opening 71 is indicated by a dotted line in FIG. 8A.

In the sectional view of FIG. 8B, one sees the four optical fibers 45A, 45B, 45C, 45D arranged one above the other in Y-direction within the ferrule 69, each with a centrally extending light-guiding region; the light-guiding region 73D for the optical fiber 45D is indicated. Furthermore, (measurement portion) beam axes 75A, 75B, 75C, 75D can be seen, along which the measurement portions of the plasma light are emitted from the optical fibers 45A, 45B, 45C, 45D. The beam axes 75A, 75B, 75C, 75D run parallel to each other, for example. This has the effect that the measurement portions essentially pass through the input slit opening 71 in the same direction and with comparable divergences in Y direction and, thus, fall onto the dispersive element and the detector for spectral analysis as quasi one light beam.

FIG. 8C schematically shows the input slit opening 71 in an inner wall 77 of the housing of the spectrometer. In the example shown, the optical fibers (with parallel fiber orientations) are arrayed linearly, wherein the array is given along a longitudinal axis of the input slit opening 71 (here along Y direction). The diameter of the light exit surfaces 67A, 67B, 67C, 67D is usually larger or lies in the range of a width of the input slit opening 71. Furthermore, the output connector 61B (outside the housing) is schematically indicated in FIG. 8C.

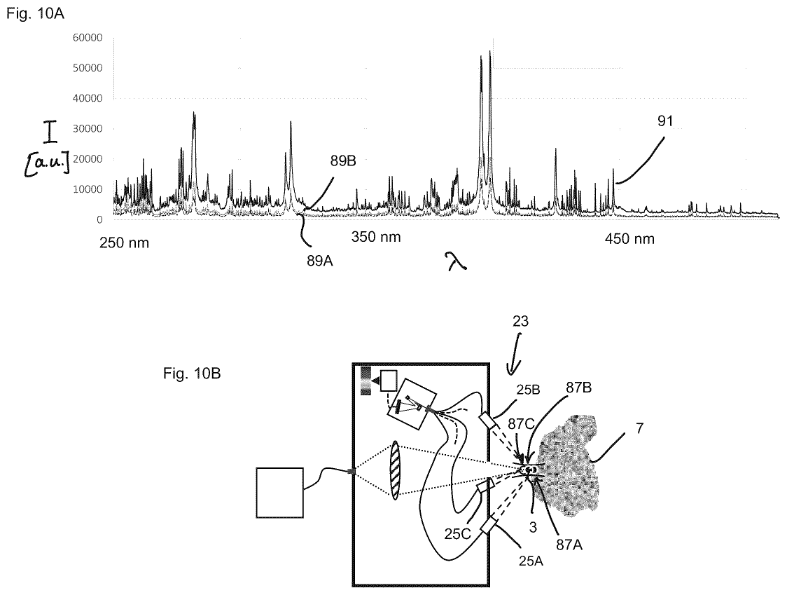

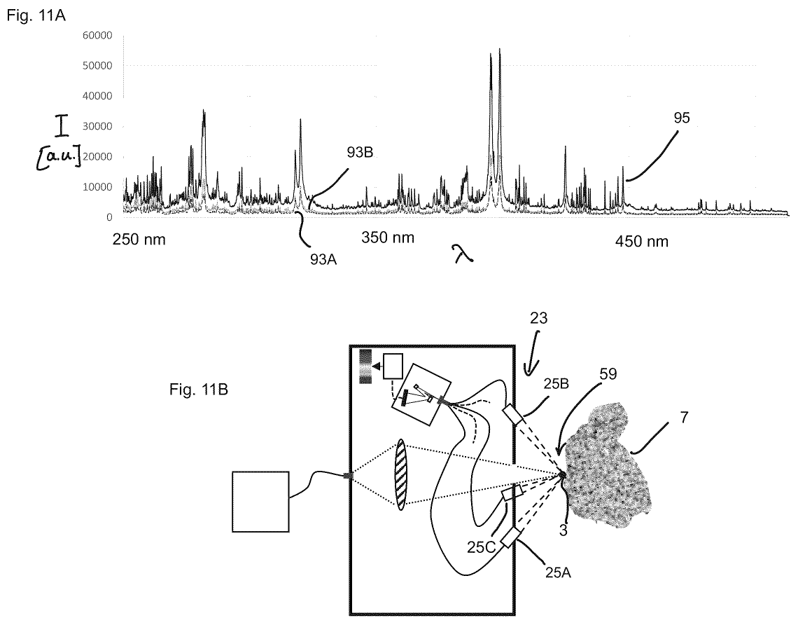

With reference to FIGS. 9A to 10B, the multifocal concept is explained with reference to exemplary measurement constellations and measurement spectra.

FIG. 9A shows two measurement spectra in the wavelength range from ca. 250 nm to ca. 500 nm and FIG. 9B shows an example of the constellation for the LIBS measurement with the spectrometer system 1 of FIG. 1. The plasma 3 is generated on the surface of the sample 7 with the laser beam. The detection unit 23 of the spectrometer system 1 is set such that the measurement detection areas of the individual objectives do not overlap. It can be seen that a measurement detection area 83A of the objective 25A is located inside the sample 7 (and accordingly the objective 25A “only” observes the sample surface at some distance from the plasma), the measurement detection area 83B of the objective 25B is located on the surface of the sample 7 (and accordingly the objective 25B observes the sample surface in the area of the plasma formation and, thus, looks directly into the plasma), and the measurement detection area 83C of the objective 25C does not overlap with the sample 7 (and accordingly the objective 25C looks over the plasma and also “only” observes the sample surface at some distance from the plasma).

In the case shown, the generated plasma 3 is comparable in its extent to the extent of the measurement detection areas of the objectives, so that the plasma 3 is essentially only present in the measurement detection area 83B and accordingly only emits light into the detection cone of the objective 25B. This can also be seen in the measurement spectra, which are shown selectively for the measurement portions of the objectives 25A and 25B in FIG. 9A for illustration. The measurement portion of the objective 25A leads to hardly any signal contributions. Accordingly, the measurement portion leads to a measurement spectrum with very low intensities I (dashed line 81A). It is noted that a measurement spectrum similar to that of objective 25A would result for objective 25C. Deviating from this, the measurement portion of objective 25B leads to a specific signal distribution with significant intensities I at specific wavelengths λ in the measurement spectrum (dotted line 81B). These allow an assignment of the elementary components of sample 7 to be determined. It is noted that in order to be able to selectively receive and display the measurement portions, only the objective to be measured is to be optically connected to the spectrometer.

If in line with the invention, all objectives are optically connected to the spectrometer for realization of the multifocal concept, the sum signal in the present case of FIG. 9B will approximately correspond to the measurement portion of objective 25B (dotted line 81B), because at the time of the measurement in FIG. 9B the measurement detection areas 83A, 83C of objective 25A and objective 25C are located in the sample 7 and in front of the sample 7, respectively. As a result, essentially only the objective 25A receives a measurement portion of the plasma 3.

FIG. 10A shows three measurement spectra in the wavelength range from about 250 nm to about 500 nm, and FIG. 10B illustrates exemplarily the constellation in a LIBS measurement in which the detection unit 23 of the spectrometer system is set such that neighboring measurement detection areas of the individual objectives partially overlap. One sees that the measurement detection area 87A of the objective 25A and the measurement detection area 87B of the objective 25B are close to the surface of sample 7, with the measurement detection area 87C of the objective 25C being to some extent further away in front of sample 7. The plasma 3 is generated on the surface of the sample 7 with the laser beam. In the example of FIG. 10B, the plasma 3 extends over the measurement detection areas 87A, 87B of the objective 25A and the objective 25B.

The situation of the resulting measurement spectra is shown in FIG. 10A, wherein the measurement spectra for objective 25A and objective 25B are also shown selectively for illustration. The measurement portion of the objective 25C leads to hardly any signal contributions and is not shown in FIG. 10A. One sees that the plasma 3 overlaps comparably with the measurement detection area 87A and the measurement detection area 87B. Accordingly, the measurement portions of objective 25A and objective 25B lead to comparable measurement spectra with significant intensities I at specific wavelengths λ in the measurement spectrum (dashed line 89A, dotted line 89B). It should be noted that in order to be able to selectively record and display the measurement components, only the lens to be measured must be optically connected to the spectrometer.

If, in line with the invention, all objectives are optically connected to the spectrometer for realization of the multilateral concept, a combined sum signal (solid line 91) results in the exemplary constellation of FIG. 10B, in which the significant intensities I at specific wavelengths λ are easily resolvable.

With reference to FIGS. 11A to 12B, the multilateral concept is explained using exemplary measurement data, wherein FIG. 11B shows the advantage of a larger recorded solid angle range and FIG. 12B shows the advantage in case of shading due to multilateral observation.

FIG. 11A shows three measurement spectra in the wavelength range from ca. 250 nm to ca. 500 nm and FIG. 11B illustrates an exemplary constellation in a LIBS measurement in which—as shown in FIG. 6B—the detection unit 23 of the spectrometer system is set in such a manner that the measurement detection ranges of the individual objectives coincide and form a common measurement detection range 59. The measurement detection area 59 is detected thereby with the different objectives from different spatial directions. It can be seen that the measurement detection range 59 is close to the surface of the sample 7. The plasma 3 is generated on the surface of the sample 7 with the laser beam in the area of the measurement detection range 59.

The situation of the resulting measurement spectra is shown in FIG. 11A, where exemplarily the (comparable) measurement spectra (dashed line 93A, dotted line 93B) for objective 25A and objective 25B are also shown selectively for illustration. The measurement portion of objective 25C results in a comparable signal contribution and is not shown. It is noted that in order to be able to selectively receive and display the measurement portions, only the objective to be measured is to be optically connected to the spectrometer.

If, in line with the invention, all objectives are optically connected to the spectrometer to realize the multifocal concept, a combined sum signal (solid line 95) is obtained in the present case of FIG. 10B, in which the significant intensities I at specific wavelengths λ can be resolved well.

FIG. 12A shows two measurement spectra in the wavelength range from ca. 250 nm to ca. 500 nm and FIG. 12B shows exemplarily the constellation in a LIBS measurement in which the geometry of the sample 7 shades all but one objective (here the objective 25B). The detection unit 23 of the spectrometer system is set according to the multilateral concept in such a manner that the measurement detection range of the individual objectives coincide and form the common measurement detection range 59. The measurement detection range 59 is detected with the different objectives from different spatial directions. The plasma 3 is generated on the surface of the sample 7 with the laser beam in the area of the measurement detection range 59.

It can be seen that the measurement detection range 59 is close to the surface of the sample 7, but material of the sample 7 is located between the plasma 3 and the objectives 25A, 25C. Accordingly, plasma light emitted in the direction of the objectives 25A, 25C is shielded by the sample 7 and, therefore, cannot be detected by the objectives 25A, 25C.

This can also be seen in the measurement spectra, which are shown selectively for the measurement portions of objectives 25A and 25B in FIG. 12A for illustration. The measurement portion of objective 25A produces hardly any signal contributions. Accordingly, the measurement portion leads to a measurement spectrum with very low intensities I (dashed line 97A). It is noted that a measurement spectrum similar to that of objective 25A would result for objective 25C. However, the measurement portion of objective 25B leads to a specific signal distribution with significant intensities I at specific wavelengths λ in the measurement spectrum (dotted line 97B). These allow an assignment of the elementary components of the sample 7 to be determined despite the shielded objectives 25B, 25C. It is noted that in order to be able to selectively receive and display the measured components, only the objective to be measured is to be optically connected to the spectrometer.

If, in line with the invention, all objectives are optically connected to the spectrometer for realization of the multilateral concept, the sum signal in the present case of FIG. 12B will approximately correspond to the measurement portion of the objective 25B (dotted line 97B), because only the objective 25A can detect a measurement portion of the plasma 3.

It should be added that subgroups of objectives can each be assigned to their own optical spectrometer, wherein the spectrometers (and optionally the light guiding systems) are adapted, for example, to different spectral ranges to be analyzed. For example, four objectives can each supply measurement portions to an optical spectrometer in the UV range and four objectives can each supply measurement portions to an optical spectrometer in the NIR range via their own light guiding systems. Alternatively or additionally, measurement portions of an objective can be divided into two light paths, for example, so that with four objectives, for example, eight optical fibers are used, of which four optical fibers form a functional output for an optical spectrometer in the UV range and four optical fibers form a functional output for an optical spectrometer in the NIR range.

The herein presented multifocal and multilateral concepts of objective arrangements in a detection unit of a spectrometer system show their advantages particularly when detecting emission spectra of a moving object (sample) to be analyzed with a surface profile modeled along the beam axis. In comparison with a spatially smaller focus zone, the expanded viewing region in the direction of the beam axis increases the portion of surface sections of the sample where, on the one hand, a plasma is generated and, on the other hand, measurement portions of this plasma can be detected by the detection unit. Accordingly, the amount of received data required to analyze the material is available more quickly. A fast analysis of the material composition is advantageous in various applications.

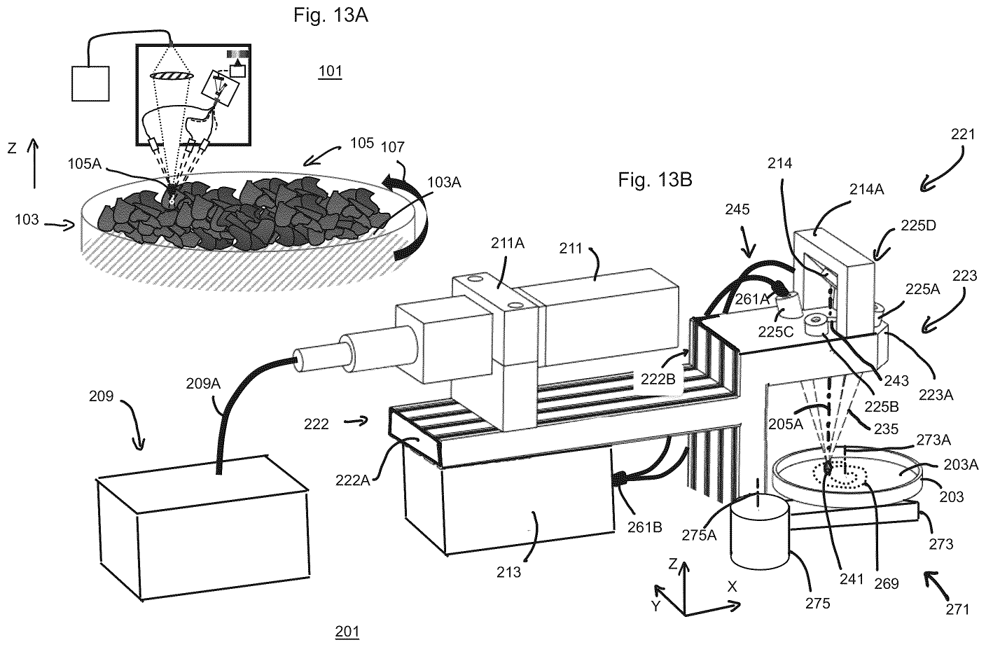

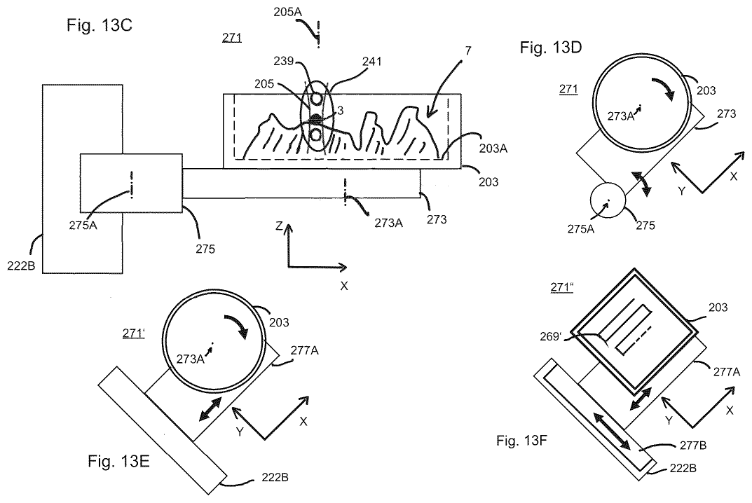

Exemplarily, FIGS. 13A to 13F show schematically implementations of a stationary spectrometer system with a permanently assigned arrangement of a sample vessel using the multifocal concept, wherein the multilateral concept can also be applied accordingly.

FIG. 13A shows a stationary installation with a spectrometer system 101. The laser beam 5 of the spectrometer system 101 is directed from above (in FIG. 13A along the Z-axis) onto a sample vessel 103 (e.g., a sample plate or a sample bowl) in which a sample 105 to be examined is provided for examination. The detection unit 23 of the spectrometer system 101 is arranged with respect to the sample vessel 103 in such a manner that a viewing region 41 of the detection unit 23 of the spectrometer system 101 (see also FIG. 2) extends at a height (distance in Z direction), for example, at a fixed height, above the bottom (sample vessel bottom surface 103A) of the sample vessel 103 and, thus, enables detection of measurement portions in a predetermined Z range.

As an example, the sample 105 consists of broken sample pieces 105A. The sample pieces 105A form a surface profile varying in the Z direction, which is generally undefined, i.e., not set. Accordingly, the surface profile comprises many measuring surface sections in which the surfaces lie in the predetermined Z-value range of the viewing region 41. If a plasma is generated on these surface areas, the plasma is located in the viewing region 41 of the detection unit 23 so that plasma light can be detected accordingly.

The laser beam 5 scans the sample 105 along an (adjustable) trajectory, for example by rotating the sample vessel 103 in the X-Y plane (indicated by arrow 107) or by one-dimensional or two-dimensional (for example, linear, row-shaped or grid-shaped) scanning by means of linear displacement in the X-Y plane, or a combination of swivel movement, translational movement and/or rotational movement, so that the trajectory comprises many measuring sections (trajectory sections). The measuring sections are assigned to measuring surface regions in which plasma light can be detected. The detection unit 23 detects plasma light always then when the laser beam 5 generates a plasma on these measuring surface regions along the measuring sections. The larger the viewing region 41 extends in Z direction, the larger the portion of the measuring surface regions on the entire surface and the correspondingly larger the portion of the measuring sections on the trajectory. The multifocal concept can therefore speed up data acquisition for spectral analysis.

It can also be seen that shading effects can occur on the sample vessel 103 with coarse-grained sample pieces 105A, for example. This means that a plasma cannot be detected at every observation angle. The multilateral concept disclosed herein (not explicitly shown in FIG. 13A, but easily transferable to this industrial application) also provides several observation directions, so that it is possible to detect a measurement portion with at least one of several intended objectives despite possible shadowing. Thus, the multilateral concept can speed up data acquisition for spectral analysis.

A short detection time, which can be achieved using the multifocal and/or multilateral concepts disclosed herein, can allow the pieces 105 to be detected with respect to material composition with short measurement trajectories along suitably located surface sections, thus, implementing a fast and/or highly accurate analysis method.

FIG. 13B shows a stationary spectrometer system 201 for laser-induced plasma spectral analysis, which exemplifies a spatially compact implementation of the arrangement shown schematically in FIG. 13A. The spectrometer system 201 comprises a laser beam source 209 which emits laser radiation (in particular, a pulsed laser beam). The laser radiation is fed to a focusing optic 211 via an optical fiber 209A, for example. The focusing optics 211 is configured to focus the laser radiation onto a sample, whereby, for spectral analysis, the sample is provided in a sample vessel 203 in the beam path of the laser radiation. The sample is not shown in FIG. 13B.

A support frame 222 forms a basic structure of the spectrometer system 201, to which optical components and the sample vessel 203 are arranged and attached. As shown in FIG. 13B, the focusing optics 211 is attached to a longitudinal rail 222A of the support frame 222 via a mount 211A. For example, the focusing optics 211 is aligned in such a manner that it emits the laser beam horizontally in X direction. Before a focus zone is formed, the tapering laser beam hits a deflecting mirror 214. In the example shown in FIG. 13B, the deflecting mirror 214 deflects the laser beam vertically downwards onto the sample to be examined. Downstream of the deflecting mirror 214, the beam axis 205A runs in Y direction. In the example shown, a sample vessel bottom surface 203A of the sample vessel 203 extends horizontally in the X-Y plane, so that the laser radiation hits the sample vertically with respect to the sample vessel bottom surface 203A.

In general, the sample vessel bottom surface 203A can be planar, so that a normal direction is defined, whereby a normal direction can generally be assigned to a sample vessel, which points vertically upwards (against gravity) when the vessel is normally stored. In FIG. 13B, the normal direction runs along the Z direction. In general, the beam axis 205A can run not only vertically (incidence of the laser radiation from above) but alternatively also at an oblique angle of incidence, for example an angle in the range from 0° to, e.g., 80°, for example, at 20°, 45° or 60° to the normal direction or axis of rotation. Such an oblique incidence of the laser beam can, for example, be directed against the direction of rotation.

The parameters of the laser radiation are matched to the material of the sample such that a plasma excitation area is formed along the beam axis 205A in the area of the focal zone of the laser radiation. The plasma excitation area has a distance to the sample vessel bottom surface 203A, and is accordingly located above the sample vessel bottom surface 203A; i.e., it is located in front of the sample vessel bottom surface 203A in the beam propagation direction. The spectrometer system 201 is configured in particular for the spectral analysis of samples with a surface that extends irregular in the Z direction. The surface extends accordingly in the X-Y plane above the sample vessel bottom surface 203A, with areas of the surface varying in their distance from the sample vessel bottom surface 203A. If a region of the surface is in the plasma excitation area and the laser radiation hits this region of the surface, this leads to a laser-induced plasma forming above the surface.

The plasma is spectrally analyzed using a detector unit 221 and an optical spectrometer 213. The detection unit 221 is configured for detecting plasma light emitted from the laser-induced plasma. For this purpose, the detection unit 221 comprises several (in the illustrated example of FIG. 13B: four) objectives 225A, 225B, 225C, 225D, which are mounted in an objective mount 223. A detection cone 235 is associated with each of the objectives 225A, 225B, 225C, 225D, which detection cone forms a plasma detection region in an overlap region with the laser radiation. If a plasma is laser-induced in the plasma detection region of an objective, a measurement portion of the plasma light can be detected accordingly by the corresponding objective.

The plasma detection regions together form a viewing region 241 of the detection unit 221. The viewing region 241 extends in the region of the plasma excitation area and, thus, in the direction of propagation of the laser radiation along the beam axis 205A. As a laser-induced plasma forms above the surface of the sample, the plasma excitation area usually overlaps with the viewing region 241, whereby the viewing region 241 can optionally also be located at least partially in front of the plasma excitation area, depending on the size of the laser-induced plasma.

In the example shown in FIG. 13B, the support frame 222 further comprises a longitudinal support plate 222B extending in the Z-direction. For example, the objective mount 223 may be formed as an integral or structurally separate section of the longitudinal support plate side member plate 222B. In the example of FIG. 13B, the objective mount 223 extends substantially in the X-Y plane and has a mount plate 223A with several (here exemplarily four) objective mount openings for receiving the objectives 225A, 225B, 225C, 225D and an optical passage opening 243 for the laser radiation. The objective mount openings and, thus, the objectives are arranged around the optical passage opening 243. For example, they are distributed around the optical passage opening 243 azimuthally at a distance of 90°. With regard to possible embodiments of the objective mount 223, it is referred to the description given herein, in particular the description of FIGS. 2 to 6B.

Furthermore, the spectrometer system 221 may comprise an optical light guiding system configured to forward measurement portions of the plasma light detected by the detection unit 221 to the optical spectrometer 213. For example, the light guiding system comprises a plurality of optical inputs and one optical output. With regard to possible embodiments of the light guiding system, it is referred to the description given herein, in particular the description of FIGS. 7A to 7E. For example, the light guiding system may comprise a plurality of optical fibers (FIG. 13B shows exemplarily two optical fibers 245). The optical fibers comprise a plurality of optical inputs for receiving light, in particular measurement portions of plasma light, from the objectives. Furthermore, the optical light guiding system can form a single optical output for emitting the light, in particular the captured measurement portions, into the optical spectrometer 213. In FIG. 13B, first ends of the optical fibers 245 are exemplarily each mounted in a connector 261A and optically connected to the corresponding objective. Second ends of the optical fibers 245 are mounted together in a connector 261B and are optically connected to the optical spectrometer 213 for coupling the measurement portions into the optical spectrometer 213. In FIG. 13B, the optical spectrometer 213 is exemplarily attached spatially close to the detection unit 221 on the longitudinal rail 222A.

In the embodiment of FIG. 13B, the deflection mirror 214 is positioned above the passage opening 243 at an angle of 45° to the X-Y plane using a retaining bracket 214A that is provided on the mounting plate 223A. Alternatively, the laser beam can be directed onto the sample vessel at an angle to the normal direction (along the Z-axis in FIG. 13B), for example by positioning the deflecting mirror 214 at an angle other than 45°, whereby the arrangement of the objectives is to be adjusted accordingly.

Furthermore, a sample vessel support 271 can be provided at the longitudinal support plate 222B as shown in FIG. 13B.

FIG. 13C shows an enlarged schematic side view of the sample vessel support 271 and FIG. 13D shows a schematic top view of the sample vessel support 271. The sample vessel support 271 is configured to move the sample vessel 203 in the X-Y plane in such a way that a plurality of sections of the surface of the sample can be positioned in the plasma excitation area for a measurement process. The sample vessel support 271 is configured in particular to affect a relative movement between the sample vessel 203 and the beam axis 205A in such a manner that the viewing region 241 scans the sample vessel bottom surface 203A at a distance along a scanning trajectory, in particular a circular, spiral, parallel lines comprising or grid-shaped trajectory. (A spiral scanning trajectory 269 is shown exemplarily in FIG. 13B.) One aim of the relative movement is that the surface of the sample is scanned during the measurement process in such a manner that a laser-induced plasma is triggered at least in sections—i.e., whenever the surface is in the plasma excitation area—from which plasma measurement portions of the emitted plasma light can then be spectrally analyzed.

For example, the sample vessel support 271 shown in FIGS. 13C and 13D comprises a rotational drive 273 configured to drive a rotational movement of the sample vessel 203 about an axis of rotation 273A. For example, the sample vessel 203, in particular the sample vessel bottom surface 203A, extends two-dimensionally in the X-Y plane. In the example, the axis of rotation 273A extends perpendicular to the X-Y plane (i.e., in the Z direction and parallel to a normal direction of the two-dimensional extension of the sample vessel. In FIG. 13B and FIG. 13C, the sample vessel bottom surface extends exemplary 203A planar in the X-Y plane; alternative shapes of the sample vessel bottom surface are, for example, convex or concave. In FIG. 13C, the beam axis 205A extends perpendicular to the X-Y plane and is parallel to a normal direction of the sample vessel bottom surface 203A. In alternative embodiments, the beam axis 205A may extend at an angle to the Z-axis/normal direction such that there is an oblique (not perpendicular from above) incidence of the laser radiation on the sample vessel 203. The rotation drive 273 in FIG. 13C enables a circular scanning trajectory of the plasma excitation area above the sample vessel 203. A radius of the circular scanning trajectory corresponds to the distance between the rotation axis 273A and the beam axis 205A in the case of incidence of the laser radiation along the Z-axis. By varying this distance, it is possible to deviate from the circular scanning trajectory, for example to implement a scanning trajectory oscillating around a circular path or a spiral-shaped scanning trajectory.

For this, the sample vessel support 271 may comprise a swivel drive 275, which is configured to displace the rotation axis 273A along a circular path in space, in the example of FIG. 13B in the X-Y plane. For example, the rotation drive 273 is attached to the swivel drive 275 for swiveling about a swivel axis 275A. The spiral scanning trajectory 269 shown in FIG. 13B can be achieved using the rotation drive 273 and the swivel drive 275.

FIG. 13C also schematically shows a sample 7 with an irregular surface profile in the Z-direction. Furthermore, according to the multifocal concept disclosed herein, a viewing region 241 is indicated that extends in the Z-direction along the beam axis 205A of a laser beam 205 and comprises a plurality of plasma detection regions 239. In the example shown, a plasma 3 is generated in the middle of the plasma detection regions, so that a measurement portion of the plasma light emitted from the plasma 3 can be detected with the objective belonging to the middle plasma detection region 239. Using a rotational movement about the axis of rotation 273A and a swivel movement about the swivel axis 275A, different areas of the surface of the sample 7 can be positioned in the viewing region 241 (see also FIG. 13D).

Due to the viewing region 241 being extended in Z direction, a correspondingly large portion of the surface of the sample 7 can be used for plasma generation and, thus, for spectral analysis. Accordingly, the measurement process can also be carried out with the sample vessel 203 being in a fixed position in Z direction. Particularly in the context of the multifocal concept, it is therefore not necessary to adjust the position of the sample vessel in Z direction or to track the sample vessel in Z direction (in order to adjust the focus and surface position). As it is therefore possible to dispense with a drive and a control of the position of the sample vessel 203 in Z direction, the design of the sample vessel support and the spectrometer system is simplified and therefore more cost-effective. Furthermore, there is no need for an, e.g., optical monitoring of a position of the sample surface in the Z-direction, as it can be used for tracking the sample vessel in Z-direction.

FIG. 13E shows an alternative embodiment of a sample vessel support 271′. As an alternative or in addition to the rotational movement about the axis of rotation 273A, the sample vessel support 271′ comprises an X-translation unit 277A that, similar to the swivel drive 275, enables the axis of rotation 273A to be displaced along a line, in the example of FIG. 13E in X-direction. In this manner, the distance between the axis of rotation 273A and the beam axis 205A can also be adjusted. The X-translation unit 277A can be attached to the longitudinal support plate 222B.

FIG. 13F shows a further alternative embodiment of a sample vessel support 271″, which comprises an X-translation unit 277A and a Y-translation unit 277B. The Y-translation unit 277B can be attached/integrated in the longitudinal support plate 222B, for example. The X translation unit 277A can be attached to the Y translation unit 277B. The translation units 277A, 277B allow, for example, scanning of offset lines (scanning trajectory 269′) or grid-shaped scanning of the sample surface by corresponding movement of the sample vessel (here a rectangularly shaped sample plate) in X- and Y-directions. A combination of both translation units 277A, 277B with a rotational movement about the rotation axis 273A is also possible.

In general, the skilled person will recognize that an alignment of the laser beam with respect to a surface of a sample (e.g., with respect to a normal direction of the surface at the location of the generated plasma) or with respect to a support surface, for example, a normal direction of a bottom surface of a sample vessel or a conveyor belt, can be selected in an angular range from 0° (incidence parallel to the normal direction) to 90° (lateral incidence), whereby an angular range from 0° to 80°, in particular from 0° to 60°, can have advantages with respect to any shadowing effects. Furthermore, the skilled person will recognize that an alignment of the laser beam with respect to a direction of movement of the sample (e.g., a linear movement or a rotational movement of the sample) can be selected in an angular range from 0° (incidence against the direction of movement) to 90° (lateral incidence) to 180° (incidence in the direction of movement).

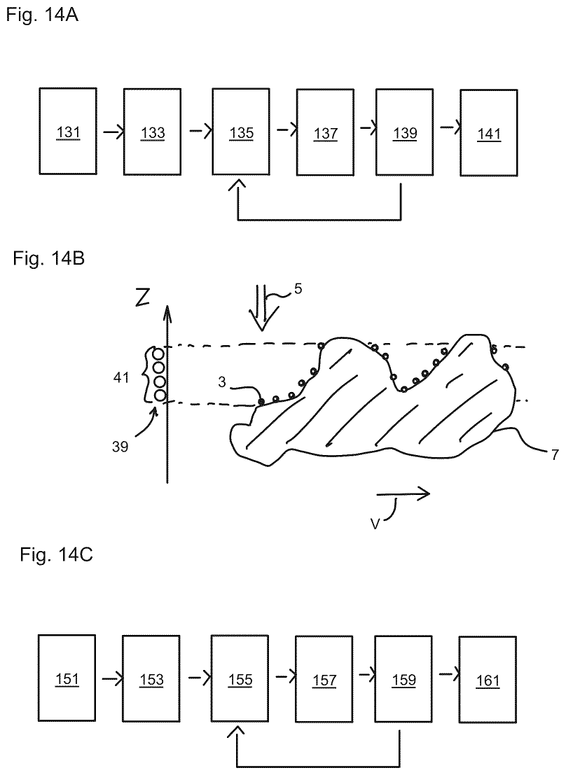

In the following, a measurement sequence according to the multifocal concept is summarized exemplarily for two measurement points with reference to FIGS. 14A and 14B:

Providing (step 131) a detection unit that provides an extended viewing region for detecting plasma light using a plurality of objectives aligned according to the multifocal concept.

Positioning (step 133) of a first surface area of a sample, for example positioned on a sample vessel, in the viewing region of the detection unit.

Irradiating (step 135) a laser beam to generate a first plasma on the first surface area, wherein plasma light is emitted from the first plasma according to a material of the sample.

Detecting (step 137) a first measurement portion of the plasma light using the detection unit and forwarding the first measurement portion of the plasma light to an optical spectrometer.

Moving (step 139) the sample relative to the viewing region, in particular as part of a continuous relative movement between the sample and the detection unit, for example, using a rotation drive and a swivel drive of the sample vessel, so that a second surface area of the sample is positioned in the viewing region.

Repeating the steps of irradiation (135) and detection (step 137) for the second surface area, so that a second measurement portion of the plasma light of a second plasma is forwarded to the optical spectrometer.

Based on the first measurement portion and the second measurement portion, outputting (step 141) a cumulative optical spectrum to a computing unit and performing a spectral analysis of the cumulative optical spectrum to determine and output the elemental composition of the sample. As part of a measurement process, spectra from different measurement constellations can be collected for a sample and, in particular, evaluated using a filter algorithm until a required quality is achieved with regard to the output analysis.

FIG. 14B shows a sample 7 that is moved past a pulsed laser beam 5 of a spectrometer system 1 at a (relative) speed v. The sample 7 has a structured surface profile that only partially extends within the viewing region 41 of the spectrometer system 1 (given by the plasma detection regions 39). Due to the pulsed laser beam 5, a sequence of plasmas was generated on the surface of the sample 7, and the plasma light was detected and spectrally analyzed accordingly. A last plasma 3 and the positions of the previously generated plasmas (circles) along the surface of the sample 7 are shown exemplarily.

In the following, a measurement sequence according to the multilateral concept is summarized exemplarily for two measuring points with reference to FIG. 14C:

Providing (step 151) a detection unit that provides an extended solid angle range for detecting plasma light using a plurality of objectives aligned according to the multilateral concept.

Positioning (step 153) of a first surface area of a sample, for example positioned on a sample vessel, in the viewing region of the detection unit.

Irradiating (step 155) a laser beam to generate a first plasma on the first surface area, wherein plasma light is emitted from the first plasma according to a material of the sample.

Detecting (step 157) a first measurement portion of the plasma light using a first subset of objectives of the detection unit and forwarding the first measurement portion of the plasma light to an optical spectrometer.

Moving (step 159) the sample relative to the viewing region, in particular as part of a continuous relative movement between the sample and the detection unit, for example, using a rotation drive and swivel drive of the sample vessel, so that a second surface area of the sample is positioned in the viewing region.

Repeating the steps of irradiating (155) and detecting (step 157) for the second surface area, wherein, due to the geometry of the sample, a second measurement portion of a plasma light of a second plasma is detected using a second subset of objectives of the detection unit different from the first subset of objectives of the detection unit, so that the second measurement portion is forwarded to the optical spectrometer.

Based on the first measurement portion and the second measurement portion, outputting (step 161) a cumulative optical spectrum to a computing unit and performing a spectral analysis of the cumulative optical spectrum to determine and output the elemental composition of the sample. As part of a measurement process, spectra from different measurement constellations can be collected for a sample and, in particular, evaluated using a filter algorithm until a required quality is achieved with regard to the output analysis.

The two measurement sequences described exemplarily above are not limited to the detection of two plasmas and correspondingly two measurement portions, but are carried out continuously for a large number of generated plasmas/measurement portions, for example, as long as the surface of the sample extends within the viewing region and, should the surface move out of the viewing region, are continued as soon as the surface re-enters the viewing region.

In the following, some aspects of a light guiding system are summarized, as it can be used, for example, in an implementation of the multifocal concept or the multilateral concept in a detection unit of a stationary spectrometer system.

Aspect A1. A light guiding system (27) comprising a plurality of optical fibers (45A, 45B, 45C, 45D), which comprise a plurality of optical inputs (29) for receiving light, in particular measurement portions (33) of plasma light, and an optical output (31) for emitting the light, in particular the detected measurement portions (33), into an optical spectrometer (13), first ends of the optical fibers (45A, 45B, 45C, 45D) are each mounted in a connector (61A) and each comprise a light entry surface (63) as optical input (29) and second ends of the optical fibers (45A, 45B, 45C, 45D) each comprise a light exit surface (67A, 67B, 67C, 67D) and are mounted together in a connector (61B), the light exit surfaces (67A, 67B, 67C, 67D) forming the optical output (31).

Aspect A2. The light guiding system (27) according to aspect A1, wherein the optical fibers (45A, 45B, 45C, 45D) are linearly arrayed on the output side and have substantially parallel fiber orientations, so that the light exit surfaces (67A, 67B, 67C, 67D) are arranged next to each other.

Aspect A3. The light guiding system (27) according to aspect A1 or aspect A2, wherein a beam axis (75A, 75B, 75C, 75D) is assigned on the output side to the light, in particular to each of the measurement portions (33) emerging from the optical light guiding system (27), and the optical fibers (45A, 45B, 45C, 45D) are arranged such that the beam axes (75A, 75B, 75C, 75D) are arranged in parallel, 75D) is assigned to the light and the optical fibers (45A, 45B, 45C, 45D) are arranged in such a way that the beam axes (75A, 75B, 75C, 75D) extend parallel to one another or extend not more than at an angle of up to 1° or up to 3° to one another.

Aspect A4. A spectrometer system (1) for spectral analysis of a plasma light (3A) emitted from a laser-induced plasma (3) comprising
a laser beam source (3) for emitting a laser beam (5), in particular, a pulsed laser beam, wherein the plasma (3) is generated on a surface (7A) of a sample (7) with the laser beam (5) propagating along a beam axis (5A);
focusing optics (11) for focusing the laser beam (5) onto the surface (7A) of the sample (7), in particular a laser head component with a focusing function such as in particular an active laser component with a focusing function acting in particular on the spectrum or the pulse duration or the pulse energy;
a detection unit (21) having a plurality of objectives and a light guiding system (27) according to one of the aspects A1 to A3, wherein each of the objectives is configured to detect a measurement portion (33) of the plasma light (3A) from objective-specific or from a common plasma detection range (59) and to couple measurement portion into the light guiding system (27) at one of the optical inputs (29); and
an optical spectrometer (13) for spectral analysis of the measurement portions (33) of the plasma light (3A) detected by the objectives, the optical spectrometer (13) being optically connected to the optical output (31) of the light guiding system (27) for receiving the measurement portions (33).

Some aspects of the multilateral concept, as it can be used, for example, in a detection unit of a stationary spectrometer system, are summarized in the following.

Aspect B1. A detection unit (21) for a spectrometer system (1) for spectral analysis of a plasma light (3A) emitted from a laser-induced plasma (3), wherein the plasma (3) is generated with a laser beam (5) propagating along a beam axis (5A) on a surface (7A) of a sample (7) (and wherein in particular a spectral splitting of the plasma light (3A) for the spectral analysis is performed in an optical spectrometer (13)), comprising:
an objective mount (23′);
a plurality of objectives (25A′, 25B′, 25C′, 25D′) mounted by the objective mount (23′), wherein a detection cone (35′) is associated with each of the objectives (25A′, 25B′, 25C′, 25D′) and the objectives (25A′, 25B′, 25C′, 25D′) are arranged and aligned in the objective mount (23′) such that the detection cones (35′) form a common plasma detection region (59) in an overlap region with the laser beam (5), from which plasma detection region a measurement portion (33) of the plasma light (3A) can be detected by each of the objectives (25A′, 25B′, 25C′, 25D′) in the case of a plasma (3) present in the plasma detection region (59).

Aspect B2. The detection unit (21′) according to aspect B1, wherein the objectives (25A′, 25B′, 25C′, 25D′) are arranged and aligned in the objective mount (23′) such that the detection cones (35′) detect measurement portions (33) of the plasma light (3A) of a plasma (3) emitted at different solid angles; and/or
wherein the objective mount (23′) provides an optical passage opening (43) through which the beam axis (5A) extends, wherein a position of the beam axis (5A) is defined in particular centrally in the optical passage opening (43); and
wherein the objective mount (23′) has, in particular, a mount plate (23A′) in which a plurality of objective mount openings (57A′, 57B′, 57C′, 57D′) for receiving the objectives (25A′, 25B′, 25C′, 25D′) and the optical passage opening (43) for the laser beam (5) are provided, and wherein the objective mount openings (57A′, 57B′, 57C′, 57D′) are arranged around the optical passage opening (43), and in particular are distributed azimuthally around the optical passage opening (43).

Aspect B3. The detection unit (21′) according to aspect B1 or B2, wherein each of the detection cones (35′) extends along an observation axis (35A′), which extends at an observation angle (a) in the range from 0° to 90° with respect to the beam axis (5A), wherein the observation angles (a) are in particular equal, do not deviate from one another by more than 3° or are distributed in an angular range of 45°; and/or wherein the objective mount (23′) has in particular a mounting plate (23A′), in which an optical passage opening (43) for the laser beam (5) is provided, wherein the beam axis (5A) extends orthogonally to the mounting plate (23A′) and at least one of the detection cones (35′) extends along an observation axis which extends at an observation angle (a) in the range from 0° to 90°, in particular 3° to 60°, for example in the range from 5° to 25°, with respect to the beam axis (5A).

Aspect B4. The detection unit (21′) according to one of the aspects B1 to B3, wherein the observation axes (35A′) of adjacent objectives (25A′, 25B′, 25C′, 25D′) are arranged azimuthally spaced around the beam axis (5A) and/or the observation axes (35A′) of the objectives (25A′, 25B′, 25C′, 25D′) lie on a cone surface around the beam axis (5A).

Aspect B5. The detection unit (21′) according to any one of aspects B1 to B4, wherein the detection unit (21) comprises two to 25, preferably four, objectives (25A′, 25B′, 25C′, 25D′); and/or
wherein the objectives (25A′, 25B′, 25C′, 25D′) are arranged azimuthally equally distributed around the beam axis (5A).

Aspect B 6. The detection unit (21) according to any one of aspects B1 to B5, further comprising an optical light guiding system (27) comprising
a plurality of optical inputs (29), each of the optical inputs (29) being optically connected to one of the objectives (25A′, 25B′, 25C′, 25D′) and being configured to receive the measurement portion (33) detected by the associated objective (25A′, 25B′, 25C′, 25D′); and
an optical output (31) for emitting the measurement portions (33) detected by the objectives (25A′, 25B′, 25C′, 25D′).

Aspect B7 The detection unit (21) according to aspect B6, wherein the optical light guiding system (27) comprises a plurality of optical fibers (45) and wherein a respective light entry surface (63) of one of the optical fibers (45) forms one of the optical inputs (29) and the objective (25A′, 25B′, 25C′, 25D′) associated with the optical input (29) images the plasma detection region (39) onto the light entry surface (63).

Aspect B8. The detection unit (21) according to aspect B7, wherein light-emitting surfaces (67A, 67B, 67C, 67D) of the optical fibers (45) form the optical output (31) and the light-emitting surfaces (67A, 67B, 67C, 67D) are arranged in a row, in particular adjacent to one another or spaced apart.

Aspect B9. The detection unit (21) according to aspect B7 or B8, wherein light-emitting surfaces (67A, 67B, 67C, 67D) of the optical fibers (45) are arranged in a row; and/or
wherein the optical fibers (45) are arrayed linearly on the output side, in particular for alignment along an input slit (19A) of an optical spectrometer (13), in which in particular a spectral splitting of the plasma light (3A) for the spectral analysis of a plasma light (3A) detected by the detection unit (21) is performed, and/or are arranged with parallel fiber orientations.

Aspect B10. A spectrometer system (1) for spectral analysis of a plasma light (3A) emitted from a laser-induced plasma (3) comprising
a laser beam source (3) for emitting a laser beam (5), in particular a pulsed laser beam, the plasma (3) being generated on a surface (7A) of a sample (7) with the laser beam (5) propagating along a beam axis (5A);
focusing optics (11) for focusing the laser beam (5) onto the surface (7A) of the sample (7);
a detection unit (21) according to one of the preceding aspects; and
an optical spectrometer (13) for spectral analysis of a plasma light (3A) detected by the detection unit (21),
whereby
   the plasma detection region (59) of the detection unit (21) is arranged in a section along the beam axis (5A), and
   the laser beam source (3) and the focusing optics (11) are configured such, and in particular beam parameters of the laser beam (5), including in particular pulse duration and pulse energy of a pulsed laser beam, are set in dependence of the material of the sample (7) such, that a plasma is generated when the surface (7A) of the sample (7) is positioned in the plasma detection regions (59).

Aspect B11. The spectrometer system (1) according to aspect B10, wherein the objectives (25A′, 25B′, 25C′, 25D′) and correspondingly the detection cones (35′) are spatially arranged in such a manner that when at least one of the objectives (25A′, 25B′, 25C′, 25D′) is shadowed, the measurement portion (33′) of the plasma light (3A) can be detected with another of the objectives (25A′, 25B′, 25C′, 25D′).

Aspect B12. The spectrometer system (1) according to aspect B10 or B11, further comprising an optical light guiding system (27) that is configured for forwarding measurement portions of the plasma light (3A) detected by the detection unit (21) to the optical spectrometer (13) and comprises a plurality of optical inputs (29) and an optical output (31);
wherein each of the optical inputs (29) is optically associated with one of the objectives (25A′, 25B′, 25C′, 25D′) and is configured to receive the measurement portion detected by the associated objective (25A′, 25B′, 25C′, 25D′); and
the optical output (31) is configured for coupling measurement portions detected by the objectives (25A′, 25B′, 25C′, 25D′) into the optical spectrometer (13).

Aspect B13. The spectrometer system (1) according to aspect B12, wherein each of the objectives (25A′, 25B′, 25C′, 25D′) is configured and arranged in the objective mount (23′) in such a manner that the measurement portion which is detected in the detection cone (35′) of one of the objectives (25A′, 25B′, 25C′, 25D′) is imaged onto the optical input (29) associated with the objective (25A′, 25B′, 25C′).

Aspect B14. The spectrometer system (1) according to one of the aspects B10 to B13, wherein a beam axis (75A, 75B, 75C, 75D) is assigned to each of the measurement portions (33) emerging from the optical light guiding system (27), and the beam axes (75A, 75B, 75C, 75D) extend parallel to one another or at no more than an angle of up to 1° or up to 3° with respect to one another.

Aspect B15. The spectrometer system (1) according to one of the aspects B10 to B14, wherein the optical spectrometer (13) comprises an input aperture (19), in particular an input slit (19A), a dispersive optical element (13A), in particular a grating, prism or grating prism (grism), and a detector (13B); and
wherein the measurement portions (33) are coupled into the optical spectrometer (13) through the input aperture (19) and are guided to the detector (13B) spectrally resolved via the dispersive optical element (13A) in order to output a spectral distribution (17) associated with all objectives (25A′, 25B′, 25C′, 25D′) of the detection unit (21).

It is explicitly emphasized that all features disclosed in the description and/or claims are to be considered separate and independent from each other for the purpose of the original disclosure as well as for the purpose of limiting the claimed invention, irrespective of the feature combinations in the embodiments and/or claims. It is explicitly stated that all range indications or indications of groups of units disclose any possible intermediate value or subgroup of units for the purpose of the original disclosure as well as for the purpose of limiting the claimed invention, in particular also as the limit of a range indication.

What is claimed is:

1. A spectrometer system (201) for laser-induced plasma spectral analysis comprising:
a laser beam source (209) for emitting an, in particular pulsed, laser beam (205);
a focusing optics (211) for focusing the laser beam (205) onto a sample (7), wherein a plasma excitation area is formed along a beam axis (205A) of the laser beam (205) in dependence of laser parameters of the laser beam (205) and a material of the sample (7) in such a manner that a surface of the sample (7) located in the plasma excitation area leads to the formation of a laser-induced plasma (3);
a detection unit (221) for detecting plasma light, which is emitted from the laser-induced plasma (3), comprising
an objective mount (223); and
a plurality of objectives (225A, 225B, 225C, 225D) mounted by the objective mount (223), wherein with each of the objectives (225A, 225B, 225C, 225D) there is associated a detection cone (235), which forms a plasma detection region (239) in an overlap region with the laser beam (205), so that when the laser-induced plasma (3) is formed in one of the plasma detection regions (239), a measurement portion of the plasma light can be detected by the corresponding one of the objectives (225A, 225B, 225C, 225D) and the plasma detection regions (239) jointly form a viewing region (241) of the detection unit (221), wherein the objectives (225A, 225B, 225C, 225D) are arranged and aligned in the objective mount (223) such that the plasma detection regions (239) are arranged offset along the beam axis (205A) and jointly form the viewing region (241) of the detection unit (221);
a sample vessel (203) with a sample vessel bottom surface (203A) on which the sample (7) can be positioned;
a sample vessel support (271, 271′) adapted to move the sample vessel (203) so that a plurality of sections of the surface of the sample (7) can be positioned in the plasma excitation area; and
an optical spectrometer (213) for spectral analysis of the measured components of the plasma light detected by the detection unit (221).

2. The spectrometer system (201) of claim 1, wherein the sample vessel support (271, 271′) is configured to affect a relative movement between the sample vessel (203) and the beam axis (205A), during which relative movement the viewing region (241) is moved at a distance over the sample vessel bottom surface (203A) along a scanning trajectory (269), in particular, a circular, spiral, linear or grid-shaped trajectory; and
wherein the sample vessel support (271, 271′) optionally comprises a rotation drive (273), a swivel drive (275), and/or a linear drive (277A, 277B) to perform the relative movement.

3. The spectrometer system (201) of claim 1, wherein the sample vessel support (271, 271′) comprises a rotation drive (273), which is configured to drive a rotational movement of the sample vessel (203) about an axis of rotation (273A), wherein the axis of rotation (273A) extends, in particular, at an angle in the range from 0° to 80° with respect to the beam axis (205A).

4. The spectrometer system (201) of claim 3, wherein the sample vessel support (271, 271′) further comprises
a swivel drive (275), which is configured to move the axis of rotation (273A) along a circular path in space; and/or
a linear drive (277A, 277B), which is configured to move the axis of rotation (273A) along an axis (X, Y) in space.

5. The spectrometer system (201) of claim 1, wherein the sample vessel support (271, 271′) comprises two linear drives (277A, 277B), which are configured to move the sample vessel (203) in a plane in space; and/or
wherein the sample vessel (203) has a two-dimensional extension and the beam axis (205A) extends at an angle in the range from 0° to 80° to a normal direction of the two-dimensional extension of the sample vessel (203).

6. The spectrometer system (201) of claim 1, further comprising a deflecting mirror (214), wherein the deflecting mirror (214) is configured to deflect the laser beam (205) between the focusing optics (11) and the sample vessel (203), in particular, by 90°; and
wherein the detection unit (221) is arranged between the deflecting mirror (214) and the sample vessel (203).

7. The spectrometer system (201) of claim 1, wherein the plasma detection regions (239)
partially overlap along the beam axis (205A), merge into one another, or are spaced apart from one another; and/or
extend along the beam axis (205A) over 0.1 mm to 15 mm and/or over 1/10 to ¼ of the viewing region (241).

8. The spectrometer system (201) of claim 1, wherein the objectives are arranged and aligned in the objective mount (223) such that the detection cones (235) form a common plasma detection region in an overlap region with the laser beam (205), from which common plasma detection region a measurement portion of the plasma light can be detected by each of the objectives in the case of a plasma (203) being in the plasma detection region; and/or
wherein each of the detection cones (235) extends along an observation axis, which extends at an observation angle (a) in the range from 0° to 90° with respect to the beam axis (205A), and the observation axes of the objectives lie, in particular, on a cone surface around the beam axis (205A).

9. The spectrometer system (201) of claim 1, wherein the objectives (225A, 225B, 225C, 225D) are arranged azimuthally spaced around the beam axis (205A); and/or
wherein the objectives (225A, 225B, 225C, 225D) are arranged and aligned in the objective mount (223) in such a manner that the detection cones (235) detect measurement portions of the plasma light of a plasma (3) emitted at different solid angles.

10. The spectrometer system (201) of claim 1, wherein the objective mount (223) comprises a mount plate (223A) in which a plurality of objective mount openings for receiving the objectives (225A, 225B, 225C, 225D) and an optical passage opening (243) for the laser beam (205) are provided, and wherein the objective mount openings are arranged around the optical passage opening (243); and/or
wherein the objectives (225A, 225B, 225C, 225D) are arranged azimuthally spaced around the beam axis (205A), in particular, azimuthally equally distributed around the beam axis (205A); and/or
wherein the detection unit (221) comprises two to 25, in particular four, objectives (225A, 225B, 225C, 225D).

11. The spectrometer system (201) of claim 1, further comprising a support frame (222), at which the focusing optics (211), the sample vessel support (271, 271′), and optionally the optical spectrometer (213) are mounted, and wherein the objective mount (223) comprises a mount plate (223A) mounted at the support frame (222) or formed as part of the support frame (222), at which the objectives are mounted and in which an optical passage opening (243) for the laser beam (205) is provided, the beam axis (205A) extending in particular orthogonally to the mounting plate (223A).

12. The spectrometer system (201) of claim 1, further comprising an optical light guiding system (27) configured for forwarding measurement portions of the plasma light detected by the detection unit (221) to the optical spectrometer (213) and comprising a plurality of optical inputs (29) and an optical output (31), wherein each of the optical inputs (29) is optically associated with one of the objectives (225A, 225B, 225C, 225D) and is adapted to receive the measurement portion detected by the associated objective (225A, 225B, 225C, 225D); and
the optical output (31) is configured for coupling measurement portions detected by the objectives (225A, 225B, 225C, 225D) into the optical spectrometer (213).

13. The spectrometer system (201) of claim 12, wherein at least one of the objectives (225A, 225B, 225C, 225D) is configured and arranged in the objective mount (223) such that a measurement portion of the plasma light, which is detected in the detection cone of the objective (225A, 225B, 225C, 225D), is imaged onto the optical input (29) associated with the objective (225A, 225B, 225C, 225D).

14. The spectrometer system (201) of claim 12, wherein a beam axis (75A, 75B, 75C, 75D) is assigned to each of the measurement portions emerging from the optical light guiding system (27), and the beam axes (75A, 75B, 75C, 75D) extend parallel to each other or do not extend under an angle of up to 1° or up to 3° with respect to each other.

15. The spectrometer system (201) of claim 1, wherein the optical spectrometer (213) comprises an input aperture (19), in particular an input slit (19A), a dispersive optical element (13A), in particular a grating, prism or grating prism, and a detector (13B); and
wherein the measurement portions are coupled through the input aperture (19) into the optical spectrometer (213) and are guided via the dispersive optical element (13A) spectrally resolved to the detector (13B) in order to output a spectral distribution (17) associated with the objectives (225A, 225B, 225C, 225D) of the detection unit (221).
